(19) United States
(12) Patent Application Publication
(10) Pub. No.: US 2006/0231311 A1
(43) Pub. Date: Oct. 19, 2006

(54) Fuel injection device for internal combustion engine

(75) Inventors: Akira Fujii, Yokkaichi-city (JP); Osamu Hishinuma, Nishio-shi (JP); Fumiaki Arikawa, Nishio-city (JP); Izumi Takahashi, Toyota-shi (JP); Akira Kiyama, Toyota-shi (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); Nippon Soken, Inc., Nishio-shi (JP); Toyota Jidosha Kabushiki Kaisha, Toyota-shi (JP)

(21) Appl. No.: 11/404,072

(22) Filed: Apr. 13, 2006

(30) Foreign Application Priority Data
Apr. 15, 2005 (JP) 2005-118599
Jun. 6, 2005 (JP) 2005-166048

(51) Int. Cl. B60S 9/21

(52) U.S. Cl. 180/200

(57) ABSTRACT

A fuel injection device wherein when the combined natural resonant period of a piezo stack and a driving member constituting part of a piezo injector of a fuel injection device is denoted by T, and the voltage rise time taken from the moment the charging to the piezo stack is initiated until the piezo stack is charged to a target charge voltage is denoted by t, then, in order to prevent oscillating loads from being applied to the piezo stack after elapse of the voltage rise time t when t≦0.5 T±0.1 T, the voltage rise time t that satisfies the relation 0.6T≦t is set in a controller for the piezo injector and, thus, the voltage rise slope of the piezo stack immediately before reaching the end of the voltage rise time t is made gentler to suppress the expansion and contraction force occurring in the piezo stack and thereby enhance the long-term reliability of the piezo stack.

### CROSS-REFERENCE TO RELATED APPLICATION

This application claims priority from, and incorporates by reference the entire disclosure of, Japanese Patent Applications No. 2005-118599, filed on Apr. 15, 2005, and No. 2005-166048, filed on Jun. 6, 2005.

### BACKGROUND OF THE INVENTION

1. Field of the Invention

The present invention relates to a fuel injection device for an internal combustion engine equipped with a piezo injector which controls fuel injection by an expansion that a piezo stack comprising a stack of piezo elements generates and, more particularly, to a fuel injection device for an internal combustion engine to which a technique for enhancing the reliability of the piezo stack is applied. Hereinafter, the internal combustion engine will be referred to simply as the engine.

2. Description of the Related Art

A piezo stack constructed by stacking piezo elements generates an expansion by expanding in the stacking direction when every piezo element is electrically charged by applying a voltage to opposite ends thereof. A piezo injector which injects fuel into the engine utilizes the property that the piezo stack generates an expansion when electrically charged, and controls the fuel injection by directly driving a needle using the piezo stack or by operating the needle by opening and closing a valve (three-way valve, two-way valve, etc.) using the piezo stack and thereby controlling the back pressure on the needle.

In the prior art, piezo stack charging techniques were only designed to start the injection when the target injection timing had arrived, and no account has been taken of the voltage rise time t taken from the moment the charging to the piezo stack is initiated until the piezo stack is charged to the target charge voltage. Such techniques are disclosed, for example, in Japanese Unexamined Patent Publication Nos. 2003-88145 and 2003-92438.

As a result, in the case of the piezo injector having a structure in which a driving member is pressed against the piezo stack, contraction and expansion repetitively occur in the piezo stack at every combined resonant period T of the piezo stack and the driving member; here, as the expansion and contraction force is directly applied to the piezo stack, there has been the possibility that the piezo stack may eventually be damaged.

### SUMMARY OF THE INVENTION

An object of the present invention is to provide a fuel injection device for an engine wherein provisions are made to prevent physical damage to a piezo stack in a piezo injector, thereby enhancing the long-term reliability of the piezo stack.

The present invention, which achieves the above object, is applied to a fuel injection device for an engine that comprises: a piezo injector comprising a piezo stack which, when electrically charged, generates an expansion in a direction in which the piezo elements are stacked, and a driving member which moves in the stacking direction by being directly driven with the expansion of the piezo stack, wherein the piezo injector performs fuel injection by causing the driving member to move in the stacking direction with the expansion of the piezo stack; and a controller for controlling charging and discharging of the piezo stack. This invention, in first to sixth modes, will be described below.

In the fuel injection device according to the first mode of the present invention, the controller for controlling the charging and discharging of the piezo stack performs a first voltage rise control that satisfies the relation 0.6 T≦t, where t is a voltage rise time taken from the moment the charging to the piezo stack is initiated until the piezo stack is charged to a target charge voltage, and T is a combined resonant period of the piezo stack and the driving member.

In this mode, as the end timing of the voltage rise time t is 0.6 T or later, the timing at which the voltage charging ends does not overlap with the timing at which the rightwardly rising slope of the load varying with the combined resonant period T becomes the greatest. Further, as the end timing of the voltage rise time t is 0.6 T or later, the voltage rise slope becomes less steep. As a result, a high load (a peak due to overshooting) occurring after the charge voltage has reached the target charge voltage can be suppressed and, at the same time, maximum expansion and maximum contraction (hereinafter peaks and dips) repetitively occurring thereafter can also be suppressed.

As the expansion and contraction force occurring in the piezo stack can be suppressed as described above, the long-term reliability of the piezo stack improves, which serves to increase the durability of the piezo injector and to enhance the reliability of the fuel injection device.

In the fuel injection device according to the second mode of the present invention, when a voltage rise time taken from the moment the charging to the piezo stack is initiated until the piezo stack is charged to a target charge voltage is denoted by t, and a combined resonant period of the piezo stack and the driving member is denoted by T, then, when 0.25 T≦t<0.6 T, the controller for controlling the charging and discharging of the piezo stack performs second voltage rise control in which average voltage rise speed during a period from 0.5 t to 1 t is made slower than average voltage rise speed during a period from the initiation of the charging to the piezo stack to 0.5 t.

In this mode, even when the end timing of the voltage rise time t is 0.5 T±0.1 T, or when it is within 0.4 T, the voltage rise slope at the end of the voltage rise time t becomes gentle. As a result, the high load (a peak due to overshooting) occurring after the charge voltage has reached the target charge voltage can be suppressed and, at the same time, peaks and dips repetitively occurring thereafter can also be suppressed. As the expansion and contraction force occurring in the piezo stack can be suppressed as described above, the long-term reliability of the piezo stack is improved, which serves to increase the durability of the piezo injector and to enhance the reliability of the fuel injection device.

In the fuel injection device according to the third mode of the present invention, when a voltage rise time taken from the moment the charging to the piezo stack is initiated until the piezo stack is charged to a target charge voltage is denoted by t, and a combined resonant period of the piezo stack and the driving member is noted by T, the controller for controlling the charging and discharging of the piezo stack performs third voltage rise control in which the voltage rise speed during a period within ±0.1 T of a load variation peak occurring in the piezo stack within the voltage rise time t from the initiation of the charging to the piezo stack until the piezo stack is charged to the target charge voltage is made slower than the voltage rise speed during the other periods, and/or the voltage rise speed during a period within ±0.1 T of a load variation minimum peak (dip) occurring in the piezo stack is made faster than the voltage rise speed during the other periods.

That is, in the third voltage rise control, the voltage rise speed before and after a peak is made slower and/or the voltage rise speed before and after a dip is made faster. With this control, the peak load that occurs the instant the driving member begins to move and the dip and peak loads that occur thereafter can be suppressed. As a result, the long-term reliability of the piezo stack is improved, which serves to increase the durability of the piezo injector and enhance the reliability of the fuel injection device.

In the fuel injection device according to the fourth mode of the present invention, when a voltage rise time taken from the moment the charging to the piezo stack is initiated until the piezo stack is charged to a target charge voltage is denoted by t, and a combined resonant period of the piezo stack and the driving member is denoted by T, the controller for controlling the charging and discharging of the piezo stack performs fourth voltage rise control in which a voltage being applied during the voltage rise time t from the initiation of the charging to the piezo stack until the piezo stack is charged to the target charge voltage is reduced for a period within ±0.1 T of a load variation peak occurring in the piezo stack.

That is, in the fourth voltage rise control, the voltage rise slope before and after a peak is made negative. With this control, the peak load that occurs the instant the driving member begins to move and the dip and peak loads that occur thereafter can be suppressed. As a result, the long-term reliability of the piezo stack improves, which serves to increase the durability of the piezo injector and enhance the reliability of the fuel injection device.

In the fuel injection device according to the fifth mode of the present invention, when a voltage rise time taken from the moment the charging to the piezo stack is initiated until the piezo stack is charged to a target charge voltage is denoted by t, and a combined resonant period of the piezo stack and the driving member is denoted by T, if there is any residual resonance occurring in the piezo stack and the driving member due to preceding injection, the controller for controlling the charging and discharging of the piezo stack performs a fifth voltage rise control in which a voltage opposite in phase to a load variation occurring due to the residual resonance is applied to the piezo stack within the voltage rise time t from the initiation of the charging to the piezo stack until the piezo stack is charged to the target charge voltage.

According to the fifth mode, when the load associated with the residual resonance increases within the voltage rise time t, the voltage rise slope is made negative by applying a voltage of opposite phase; therefore, the load increasing speed is slowed, and the occurrence of a high load can be suppressed. As a result, the long-term reliability of the piezo stack improves, which serves to increase the durability of the piezo injector and enhance the reliability of the fuel injection device.

Further, according to the fifth mode, when the load associated with the residual resonance increases to within the voltage rise time t, the voltage rise slope is made negative, and the load increasing speed is thus slowed; this serves to avoid the problem that the injection timing occurs earlier. Conversely, when the load associated with the residual resonance decreases to within the voltage rise time t, the voltage rise slope is made steeper, thereby avoiding a situation where the expansion of the piezo stack is restricted; this serves to avoid the problem that the injection timing is delayed.

In the fuel injection device according to the sixth mode of the present invention, the controller for controlling the charging and discharging of the piezo stack in the fifth mode performs sixth voltage rise control in which the voltage opposite in phase to the load variation occurring due to the residual resonance is applied to the piezo stack even after the voltage rise time t has elapsed. With this control, the occurrence of dip and peak loads after the voltage rise time t has elapsed can be suppressed, and the long-term reliability of the piezo stack can be enhanced.

The present invention, which achieves the earlier described object, can also be applied to a fuel injection device for an engine equipped with a piezo injector, wherein the piezo injector comprises a piezo stack which, when electrically charged, generates an expansion in a direction in which piezo elements are stacked, and a driving member which moves in the stacking direction by being directly driven with the expansion of the piezo stack, and the piezo injector performs fuel injection by causing the driving member to move in the stacking direction with the expansion of the piezo stack. This invention will be described in seventh to 18th modes below.

In the seventh mode of the present invention, a friction coefficient reducing means for reducing friction coefficient is provided in a portion where the driving member contacts a slidable holding member which slidably holds the driving member. With this arrangement, it becomes possible to suppress the peak load that occurs the instant the driving member begins to move after the piezo stack began to expand. By thus suppressing the peak load applied to the piezo stack, the long-term reliability of the piezo stack is improved, which serves to increase the durability of the piezo injector and enhance the reliability of the fuel injection device.

In the eighth mode of the present invention, between the piezo stack and a fixed member which accepts the expansion of the piezo stack at an end opposite from the driving member, there is provided a low-rigidity portion whose rigidity is lower than the rigidity of the fixed member. With this arrangement, the load occurring in the fixed member side of the piezo stack is relieved by being absorbed by the deformation of the low-rigidity portion. This serves to prevent damage from being caused to the piezo elements in the fixed member side of the piezo stack, and to enhance the long-term reliability of the piezo stack; as a result, the durability of the piezo injector increases, enhancing the reliability of the fuel injection device.

In the ninth mode of the present invention, the fixed member in the eight mode is formed from stainless steel, and the low-rigidity portion is formed from a low-rigidity member having a Young's modulus of 10 GPa or less. With this arrangement, the load occurring in the fixed member side of the piezo stack is relieved by being absorbed by the deformation of the low-rigidity member.

In the 10th mode of the present invention, the low-rigidity portion in the ninth mode is provided on a face where the fixed member accepts the expansion of the piezo stack, and is formed as a roughened surface having a surface roughness of 1.6 Z or larger and a Young's modulus of 10 GPa or less. With this arrangement, the load occurring in the fixed member side of the piezo stack is relieved by being absorbed by the deformation of the roughened surface.

In the 11th mode of the present invention, of the piezo elements forming the piezo stack, the piezo element located at the end opposite from the driving member (i.e., the end facing the fixed member) has a structure that reduces internal stress compared with the piezo element located at the end nearer to the driving member. As, of the piezo elements forming the piezo stack, the stress acting on the piezo element located at the end facing the fixed member is relieved by this structure, the piezo element located at the end facing the fixed member can be prevented from being damaged. As a result, the long-term reliability of the piezo stack improves, increasing the durability of the piezo injector and thus enhancing the reliability of the fuel injection device.

In the 12th mode of the present invention, of the piezo elements forming the piezo stack, the piezo element located at the end opposite from the driving member (i.e., the end facing the fixed member) in the 11th mode has a larger device diameter than the piezo element located at the end nearer to the driving member. Increasing the device diameter of the piezo element located at the end facing the fixed member serves to spread out the internal stress.

In the 13th mode of the present invention, of the piezo elements forming the piezo stack, the device diameter of the piezo element located at the end facing the fixed member in the 12th mode is 3% or more larger than the device diameter of the piezo element located at the end nearer to the driving member.

In the 14th mode of the present invention, of the piezo elements forming the piezo stack, the piezo element located at the end facing the fixed member in the 11th mode has a greater thickness than the piezo element located at the end nearer to the driving member. Increasing the thickness of the piezo element located at the end facing the fixed member serves to spread out the internal stress.

In the 15th mode of the present invention, of the piezo elements forming the piezo stack, the thickness of the piezo element located at the end facing the fixed member in the 14th mode is 3% or more greater than the thickness of the piezo element located at the end nearer to the driving member.

In the 16th mode of the present invention, of the piezo elements forming the piezo stack, the piezo element located at the end facing the fixed member has a greater device strength than the piezo element located at the end nearer to the driving member. As, of the piezo elements forming the piezo stack, the device strength of the piezo element located at the end facing the fixed member is made greater, the piezo element located at the end facing the fixed member can be prevented from being damaged. As a result, the long-term reliability of the piezo stack improves, increasing the durability of the piezo injector and thus enhancing the reliability of the fuel injection device.

In the 17th mode of the present invention, of the piezo elements forming the piezo stack, the device strength of the piezo element located at the end facing the fixed member in the 16th mode is 10% or more greater than the device strength of the piezo element located at the end nearer to the driving member.

In the 18th mode of the present invention, a resilient member for applying a compressing force to the piezo stack is provided between the piezo stack and the fixed member which accepts the expansion of the piezo stack at the end opposite from the driving member. By thus disposing the resilient member for applying a compressing force to the piezo stack, if a contraction causing an abrupt drop in the applied load occurs during the charging to the piezo stack, the contraction force causing an abrupt drop in the applied load is absorbed by the resilient member, thus avoiding the problem that an abrupt drop in the load (an abrupt tensile load) is caused to the piezo stack.

By thus suppressing the dip load applied to the piezo stack, the long-term reliability of the piezo stack improves, increasing the durability of the piezo injector and thus enhancing the reliability of the fuel injection device.

### BRIEF DESCRIPTION OF THE DRAWINGS

The present invention is illustrated by way of example, and not limitation, in the figures of the accompanying drawings in which like reference numerals indicate similar elements. Note that the following figures are not necessarily drawn to scale.

FIG. 1A is a characteristic diagram showing how a displacement occurring in a piezo stack varies with time t after the charging to the piezo stack is started when the rise time (voltage rise time) is within one half of combined resonant period T. (Prior art)

FIG. 1B is a characteristic diagram showing how a displacement occurring in a piezo stack varies with time t after the charging to the piezo stack is started when the rise time (voltage rise time) is equal to combined resonant period T. (First embodiment)

FIG. 1C is a characteristic diagram showing how the displacement occurring in the piezo stack varies with time t after the charging to the piezo stack is started when the rise time (voltage rise time) is equal to 1.5 times the combined resonant period T. (First embodiment)

FIG. 2 is a schematic diagram showing a fuel injection device. (First embodiment)

FIG. 3 is a schematic diagram showing a fuel injection device. (First embodiment)

FIG. 4 is a cross-sectional view of a piezo injector. (First embodiment)

FIG. 5A is a schematic diagram showing the operation of the piezo injector when the piezo stack expands allowing fuel to be injected. (First embodiment)

FIG. 5B is a schematic diagram showing the operation of the piezo injector when the piezo stack contracts causing the fuel injection to stop. (First embodiment)

FIG. 6 is a schematic diagram showing the piezo stack. (First embodiment)

FIG. 7 is an electric circuit diagram of a charge/discharge circuit. (First embodiment)

FIG. 8 is a schematic diagram showing a temperature compensation circuit. (First embodiment)

FIG. 9 is a diagram for explaining the operation of the charge/discharge circuit. (First embodiment)

FIG. 10A is a characteristic diagram showing how the displacement occurring in the piezo stack varies with time t after the charging to the piezo stack is started when the voltage rise time is within one half of the combined resonant period T.

FIG. 10B is a characteristic diagram showing how the displacement occurring in the piezo stack varies with time t after the charging to the piezo stack is started when the voltage rise time is within one half of the combined resonant period T but when the voltage rise speed during the period immediately before the end of the voltage rise time is made slower. (Second embodiment)

FIG. 11 is a time chart showing a load variation as a function of time. (Reference example)

FIG. 12 is a time chart showing variations in charge voltage and load along a time axis. (Third embodiment)

FIG. 13 is a time chart showing variations in charge voltage and load along a time axis. (Fourth embodiment)

FIG. 14 is a time chart showing variations in charge voltage and load along a time axis. (Fifth embodiment)

FIG. 15 is a schematic diagram showing a piezo injector. (Sixth embodiment)

FIG. 16 is a schematic diagram showing a piezo stack. (Seventh embodiment)

FIG. 17 is a schematic diagram showing a piezo stack. (Eighth embodiment)

FIG. 18 is a schematic diagram showing a piezo stack. (Ninth, 10th, and 11th embodiments)

FIG. 19 is a schematic diagram showing a piezo stack. (12th embodiment)

### DESCRIPTION OF THE PREFERRED EMBODIMENTS

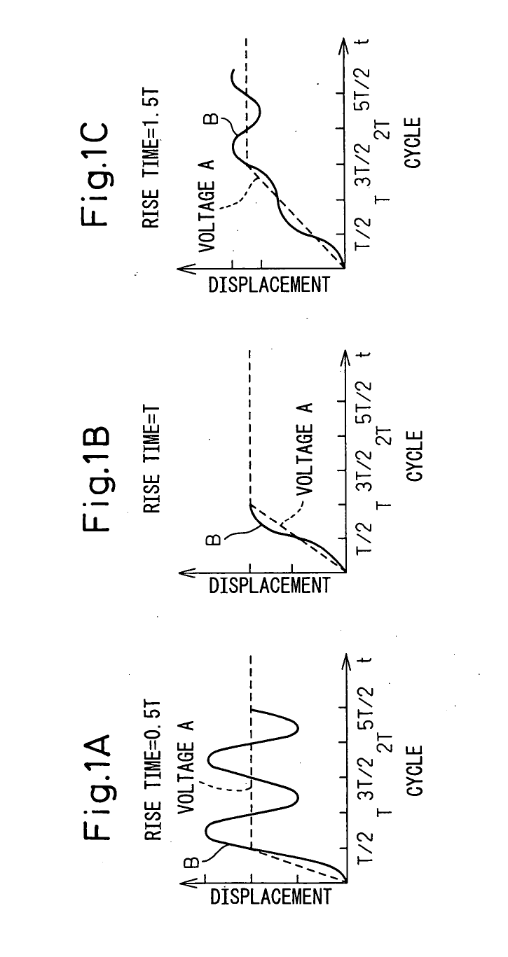

Before describing the preferred embodiments, an explanation will be given of the prior art problems by using FIG. 1A.

A first problem is that, because of the piezo injector structure in which the driving member is pressed against the piezo stack, there exists a combined resonant period T between the piezo stack and the driving member. As a result, in an ideal (imaginary) condition in which external loads such as friction are not applied to the piezo stack or the driving member, the rightwardly rising slope of the load varying with the combined resonant period T (the rightwardly rising slope of the resonant frequency) becomes the greatest at time 0.5 T±0.1 T after the charging is started.

As previously described, in the prior art techniques, no account has been taken of the voltage rise time t. Therefore, there can occur cases where, after the charging to the piezo stack is started, the end of the voltage rise time t is reached at time 0.5 T±0.1 T. In such cases, even when the charge voltage has reached the target charge voltage, and the voltage has stopped rising, the displacement occurring in the expanding direction due to the piezo stack and the driving member does not stop, and the expansion load (the load acting in the stacking direction of the piezo stack) continues to increase, resulting in the occurrence of a high load (a peak due to overshooting).

Thereafter, dips and peaks occur repetitively with a combined resonant period T. As such expansion and contraction force are applied directly to the piezo stack, the piezo stack may eventually be damaged. That is, if the end timing of the voltage rise time t is 0.5 T±0.1 T, the long-term reliability of the piezo stack drops.

A second problem is that, when the timing at which the end of the voltage rise time t is reached after the charging to the piezo stack is started is within 0.4 T, the voltage rise slope is extremely great. Because of this second problem, even when the charge voltage has reached the target charge voltage, and the voltage has stopped rising, the displacement occurring in the expanding direction due to the piezo stack and the driving member does not stop and, as described above, the expansion load continues to increase, resulting in the occurrence of a high load (a peak due to overshooting; thereafter, dips and peaks occur repetitively at every combined resonant period T. As such expansion and contraction force are applied directly to the piezo stack, the piezo stack may eventually be damaged. That is, when the voltage rise time t is within 0.4 T, the long-term reliability of the piezo stack also drops.

The first and second problems described above have shown the problems that can occur in an ideal (imaginary) condition in which external loads such as friction are not applied to the piezo stack or the driving member. In reality, however, external loads such as friction are applied to the piezo stack and the driving member. Considering this, a third problem, as a realistic problem, will be described below.

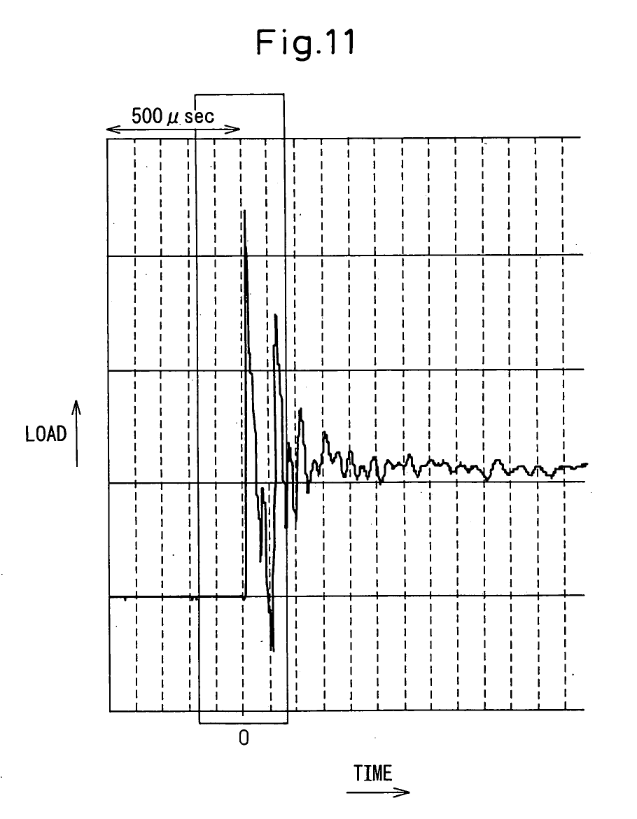

When the charging is started, the piezo stack begins to generate an expansion load. After the piezo stack begins to expand, the expansion load reaches a maximum the instant the driving member begins to move. To describe a specific example with reference to FIG. 11, a load variation peak occurs in the piezo stack at a time instant 21 (μs) after the initiation of the charging to the piezo stack. Thereafter, dips and peaks occur repetitively. As such expansion and contraction force are applied directly to the piezo stack, the piezo stack may eventually be damaged. That is, because of the occurrence of peaks and dips of the load variation, the long-term reliability of the piezo stack drops.

Injectors, not specifically limited to piezo injectors, may perform multiple injections in which injections are repeated at short intervals. A fourth problem is one that can arise in such cases. To give a specific example, a pilot injection with a short injection time may be performed and may be immediately followed by a main injection with a long injection time. In this case, resonance that occurred during the pilot injection may extend into the voltage rise time t for the main injection that follows. Here, the resonance due to the preceding injection that affects the following injection will be referred to as the residual resonance.

If the residual resonance extends into the voltage rise time t, the load variation due to the residual resonance will be superimposed on the load variation due to the rising voltage. More specifically, when the load is increasing due to the residual resonance, if the voltage to the piezo stack is raised, the load increasing speed further increases, and a high load due to the superimposition results. Since such a high load is applied directly to the piezo stack, the piezo stack may eventually be damaged.

If the residual resonance extends into the voltage rise time t, there can arise the following problem in addition to the above problem. When the load is increasing due to the residual resonance, if the voltage to the piezo stack is raised, the rise timing of the expansion load is advanced, and as a result, the injection timing may occur earlier. Conversely, when the load decreases due to the residual resonance, if the voltage to the piezo stack is raised with a constant slope, the injection timing may be delayed because the expansion of the piezo stack is restricted.

A fifth problem is that, while the expansion load occurring in the piezo stack is transmitted to the driving member, the side of the piezo stack opposite from the driving member is supported by a fixed member. That is, the structure is such that the expansion at the side of the piezo stack opposite to the driving member is accepted by the fixed member. On the other hand, the load occurring in the driving member side of the piezo stack is relieved as the driving member moves.

However, the load occurring in the side of the piezo stack opposite from the driving member is not released to the outside but is exerted on the piezo elements in the fixed member side of the piezo stack, as the fixed member side of the piezo stack is rigidly held by the fixed member. As a result, the piezo elements located nearer to the fixed member (especially, the one nearest to the fixed member) are subjected to a large stress. Therefore, the piezo elements located nearer to the fixed member (especially, the one nearest to the fixed member) are prone to damage, and thus the long-term reliability of the piezo stack drops.

A sixth problem is one associated with the phenomenon described in connection with the third problem, that is, after the charging to the piezo stack is started the expansion load reaches a maximum the instant the driving member begins to move. As the driving member begins to move under the maximum load immediately after that, a dip occurs as the applied load abruptly drops. The piezo elements forming the piezo stack are sensitive to impact, and may be damaged not only when a high load is applied as earlier described, but also when an abrupt load drop occurs. That is, an abrupt dip load occurring in the piezo stack can lead to a degradation of the long-term reliability of the piezo stack.

First to tenth best modes of the present invention will be described below. The first to fifth best modes aim to enhance the reliability of the piezo stack by controlling the voltage charging to the piezo stack, while the sixth to tenth best modes aim to enhance the reliability of the piezo stack by ingeniously designing the mechanical structure of the piezo injector.

The fuel injection device of the first best mode comprises: a piezo injector comprising a piezo stack which generates an expansion in a direction in which piezo elements are stacked, and a driving member which moves in the stacking direction by being directly driven with the expansion of the piezo stack, wherein the piezo injector performs fuel injection by causing the driving member to move in the stacking direction with the expansion of the piezo stack; and a controller for controlling charging and discharging of the piezo stack. The controller performs first voltage rise control that satisfies the relation 0.6 T≦t, where t is a voltage rise time taken from the moment the charging to the piezo stack is initiated until the piezo stack is charged to a target charge voltage, and T is a combined resonant period of the piezo stack and the driving member.

The fuel injection device of the second best mode comprises: a piezo injector comprising a piezo stack which generates an expansion in a direction in which piezo elements are stacked, and a driving member which moves in the stacking direction by being directly driven with the expansion of the piezo stack, wherein the piezo injector performs fuel injection by causing the driving member to move in the stacking direction with the expansion of the piezo stack; and a controller for controlling charging and discharging to the piezo stack. When a voltage rise time taken from the moment the charging to the piezo stack is initiated until the piezo stack is charged to a target charge voltage is denoted by t, and a combined resonant period of the piezo stack and the driving member is denoted by T, then when 0.25 T≦t<0.6 T, the controller performs second voltage rise control in which average voltage rise speed during a period from 0.5 t to 1 t is made slower than average voltage rise speed during a period from the initiation of the charging to the piezo stack to 0.5 t.

The fuel injection device of the third best mode comprises: a piezo injector comprising a piezo stack which generates an expansion in a direction in which piezo elements are stacked, and a driving member which moves in the stacking direction by being directly driven with the expansion of the piezo stack, wherein the piezo injector performs fuel injection by causing the driving member to move in the stacking direction with the expansion of the piezo stack; and a controller for controlling charging and discharging of the piezo stack.

When a voltage rise time taken from the moment the charging to the piezo stack is initiated until the piezo stack is charged to a target charge voltage is denoted by t, and a combined resonant period of the piezo stack and the driving member is denoted by T, the controller performs third voltage rise control in which voltage rise speed during a period within ±0.1 T of a load variation peak occurring in the piezo stack within the voltage rise time t from the initiation of the charging to the piezo stack until the piezo stack is charged to the target charge voltage is made slower than the voltage rise speed during the other periods, and/or voltage rise speed during a period within ±0.1 T of a load variation dip occurring in the piezo stack is made faster than the voltage rise speed during the other periods.

The fuel injection device of the fourth best mode comprises: a piezo injector comprising a piezo stack which generates an expansion in a direction in which piezo elements are stacked, and a driving member which moves in the stacking direction by being directly driven by the expansion of the piezo stack, wherein the piezo injector performs fuel injection by causing the driving member to move in the stacking direction with the expansion of the piezo stack; and a controller for controlling charging and discharging of the piezo stack.

When a voltage rise time taken from the moment the charging to the piezo stack is initiated until the piezo stack is charged to a target charge voltage is denoted by t, and a combined resonant period of the piezo stack and the driving member is denoted by T, the controller performs fourth voltage rise control in which a voltage being applied during the voltage rise time t from the initiation of the charging to the piezo stack until the piezo stack is charged to the target charge voltage is reduced for a period within ±0.1 T of a load variation peak occurring in the piezo stack.

The fuel injection device of the fifth best mode comprises: a piezo injector comprising a piezo stack which generates an expansion in a direction in which piezo elements are stacked, and a driving member which moves in the stacking direction by being directly driven with the expansion of the piezo stack, wherein the piezo injector performs fuel injection by causing the driving member to move in the stacking direction with the expansion of the piezo stack; and a controller for controlling charging and discharging of the piezo stack.

When a voltage rise time taken from the moment the charging to the piezo stack is initiated until the piezo stack is charged to a target charge voltage is denoted by t, and a combined resonant period of the piezo stack and the driving member is denoted by T, if there is any residual resonance occurring in the piezo stack and the driving member due to preceding injection, the controller performs fifth voltage rise control in which a voltage opposite in phase to a load variation occurring due to the residual resonance is applied to the piezo stack within the voltage rise time t from the initiation of the charging to the piezo stack until the piezo stack is charged to the target charge voltage.

The fuel injection device of the sixth best mode is equipped with a piezo injector comprising: a piezo stack which generates an expansion in a direction in which piezo elements are stacked; and a driving member which moves in the stacking direction by being directly driven with the expansion of the piezo stack, wherein the piezo injector performs fuel injection by causing the driving member to move in the stacking direction of the piezo stack. Here, a friction coefficient reducing member for reducing friction coefficient is provided in a portion where the driving member contacts a slidable holding member which slidably holds the driving member.

The fuel injection device of the seventh best mode is equipped with a piezo injector comprising: a piezo stack which generates an expansion in a direction in which piezo elements are stacked; and a driving member which moves in the stacking direction by being directly driven with the expansion of the piezo stack, wherein the piezo injector performs fuel injection by causing the driving member to move in the stacking direction of the piezo stack. Here, between the piezo stack and a fixed member which accepts the expansion of the piezo stack at an end opposite from the driving member, there is provided a low-rigidity portion having lower rigidity than the fixed member.

The fuel injection device of the eighth best mode is equipped with a piezo injector comprising: a piezo stack which generates an expansion in a direction in which piezo elements are stacked; and a driving member which moves in the stacking direction by being directly driven with the expansion of the piezo stack, wherein the piezo injector performs fuel injection by causing the driving member to move in the stacking direction of the piezo stack. Here, of the piezo elements forming the piezo stack, the piezo element located at an end opposite from the driving member has a structure that reduces internal stress compared with the piezo element located at an end nearer to the driving member.

The fuel injection device of the ninth best mode is equipped with a piezo injector comprising: a piezo stack which generates an expansion in a direction in which piezo elements are stacked; and a driving member which moves in the stacking direction by being directly driven with the expansion of the piezo stack, wherein the piezo injector performs fuel injection by causing the driving member to move in the stacking direction of the piezo stack. Here, of the piezo elements forming the piezo stack, the piezo element located at an end opposite from the driving member is made to have a greater device strength than the piezo element located at an end nearer to the driving member.

The fuel injection device of the 10th best mode is equipped with a piezo injector comprising: a piezo stack which generates an expansion in a direction in which piezo elements are stacked; and a driving member which moves in the stacking direction by being directly driven with the expansion of the piezo stack, wherein the piezo injector performs fuel injection by causing the driving member to move in the stacking direction of the piezo stack. Here, a resilient member for applying a compressing force to the piezo stack is interposed between the piezo stack and a fixed member which accepts the expansion of the piezo stack at an end opposite from the driving member.

### FIRST EMBODIMENT

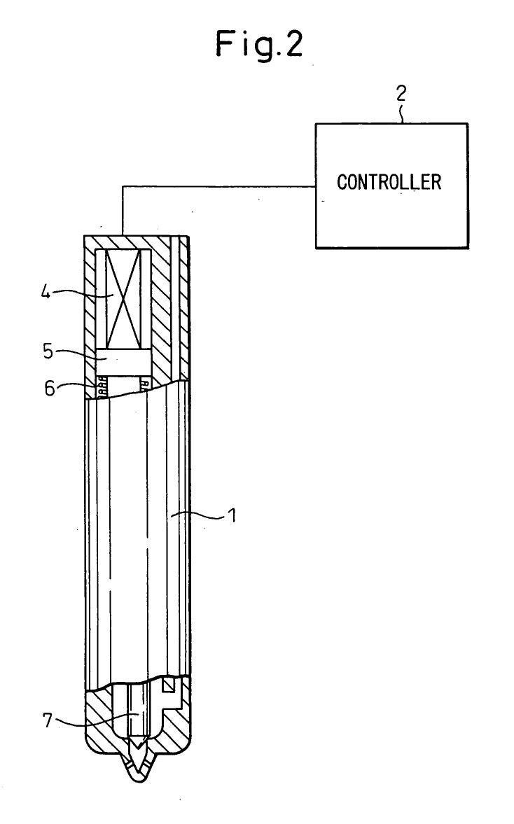

A first embodiment of the present invention will be described below with reference to FIGS. 1B to 9. First, the basic configuration of the fuel injection device will be described with reference to FIG. 2. The fuel injection device comprises a piezo injector 1 to which fuel is supplied from the outside, and a controller 2 which controls the operation of the piezo injector 1.

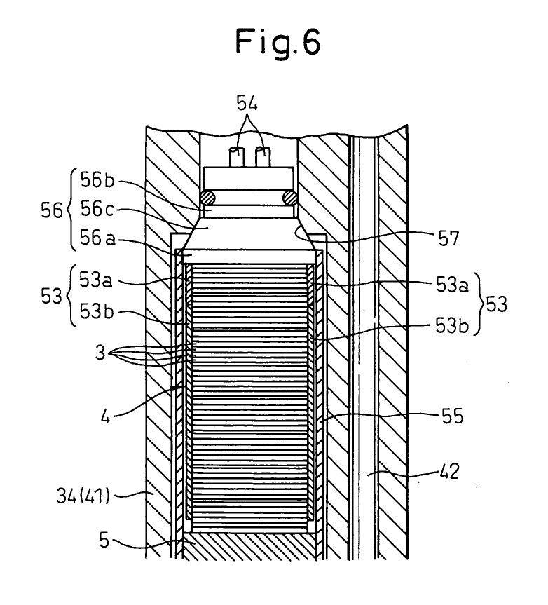

The piezo injector 1 comprises a piezo stack 4 constructed from a stack of piezo elements 3 (see FIG. 6) which, when electrically charged, generates an expansion in the stacking direction, and a driving member 5 which moves in the stacking direction by being directly driven with the expansion of the piezo stack, and the piezo injector 1 performs fuel injection by causing the driving member 5 to move in the stacking direction. The piezo injector 1 is provided with a first return spring 6 which compresses the piezo stack 4 via the driving member 5, the structure being such that the instant the piezo stack 4 loses its expansion (expansive force) by being discharged, the piezo stack 4 is compressed, causing the driving member 5 to move in the stacking direction opposite to the direction of the expansion.

That is, the piezo injector 1 utilizes the property that the piezo stack 4 generates the expansion when electrically charged, and controls the fuel injection on/off by directly driving a needle 7 using the piezo stack 4 or by operating the needle 7 by opening and closing a valve (three-way valve, two-way valve, etc.) using the piezo stack 4 and thereby controlling the back pressure of the needle 7.

The controller 2 is equipped with a charge/discharge control function for controlling the charging/discharging to the piezo stack, which is implemented as a control program for the piezo injector 1. The charge/discharge control function includes a function for performing first voltage rise control that satisfies the relation
0.6 T≦t
where t is the voltage rise time taken from the moment the charging to the piezo stack 4 is initiated until the piezo stack 4 is charged to the target charge voltage, and T is the combined resonant period of the piezo stack 4 and the driving member 5.

That is, the controller 2 is equipped with a function for lowering the voltage rise slope just before the end of the voltage rise time t, by deliberately making the voltage rise time t equal to or longer than 0.6 T and thereby preventing the timing at which the voltage charging to the piezo stack 4 ends (the end of the voltage rise time t) from overlapping with the timing at which the rightwardly rising slope of the load varying with the combined resonant period T (the rightwardly rising slope of the resonant frequency) becomes the greatest or nearly the greatest.

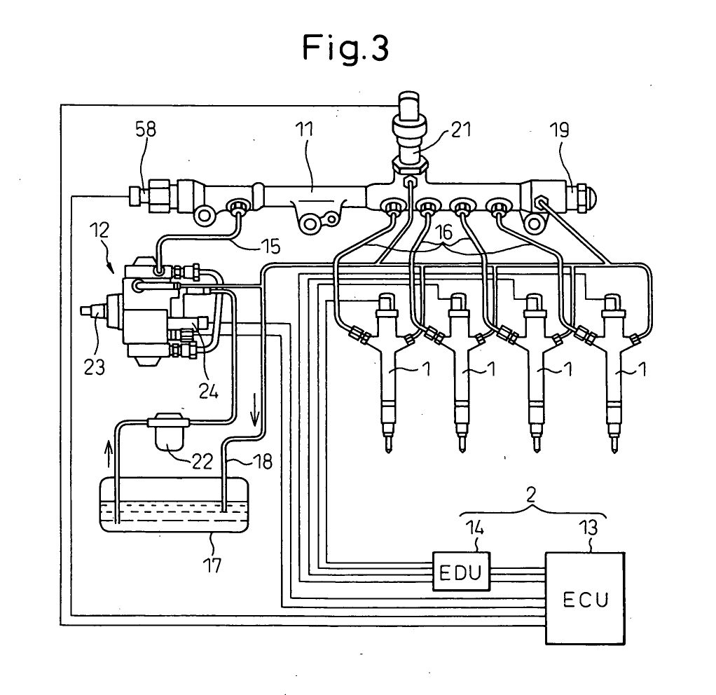

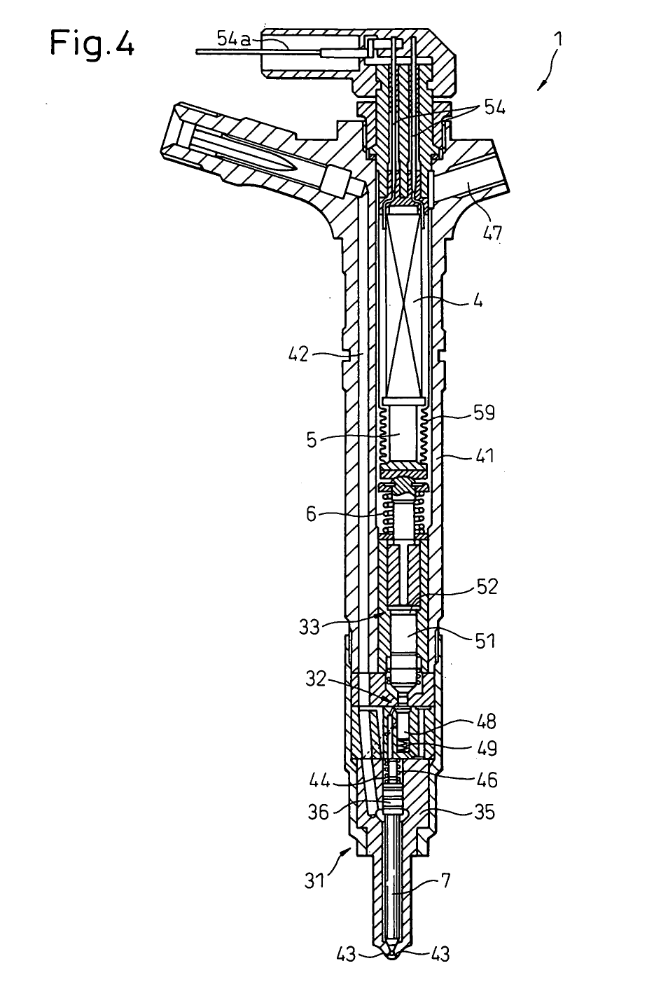

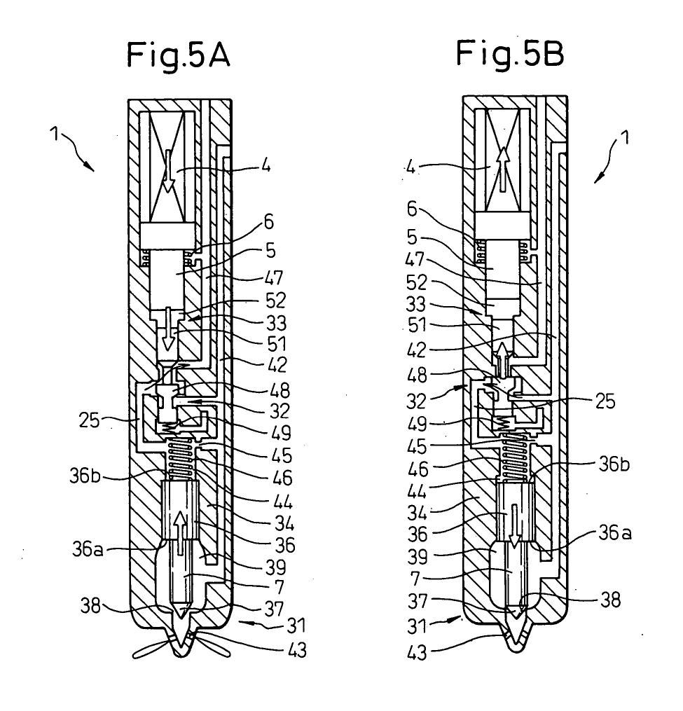

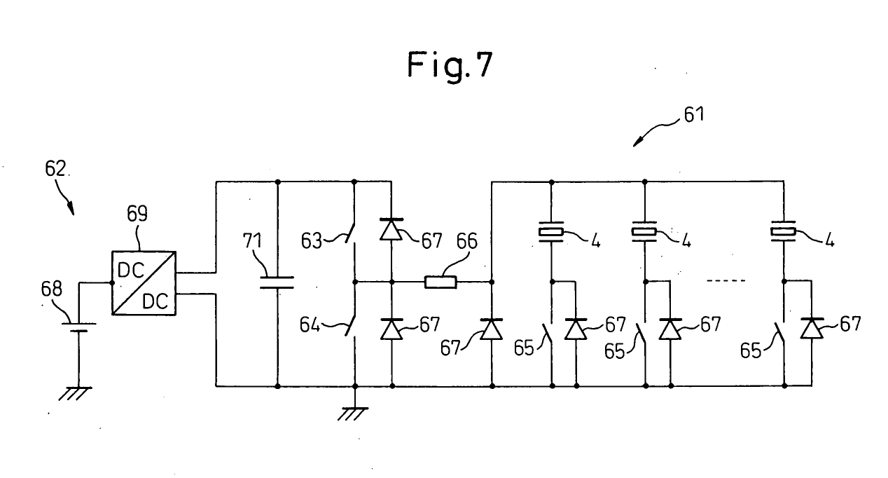

The fuel injection device will be described in further detail below. First, as one specific example of the fuel injection device, a common rail fuel injection device will be described with reference to FIG. 3; thereafter, as one specific example of the piezo injector 1, a three-way valve type piezo injector will be described with reference to FIGS. 4, 5, etc., followed by the description of one example of the piezo stack 4 with reference to FIG. 6, etc., which is further followed by the description of one specific example of the controller 2 with reference to FIGS. 7 to 9, etc.

The system configuration of the fuel injection device will be described with reference to FIG. 3. The fuel injection device is a system for injecting fuel into the cylinders of an engine (for example, a diesel engine not shown) and comprises, in addition to the piezo injectors 1 and the controller 2, a common rail 11, a supply pump 12, etc. Here, the controller 2 comprises an ECU (Engine Control Unit) 13 and an EDU (Electronic Drive Unit) 14; the EDU 14 may be contained within the casing of the ECU 13.

The common rail 11 is a pressure accumulator which accumulates the fuel at high pressure for supply to the piezo injectors 1, and is connected to the exhaust port of the supply pump 12 which supplies the fuel under pressure through a high-pressure pump pipe 15 so that a common rail pressure corresponding to the fuel injection pressure is accumulated; further, a plurality of injector pipes 16 for supplying the high-pressure fuel to the respective piezo injectors 1 are connected to the common rail 11.

A relief pipe 18 for returning fuel from the common rail 11 to the fuel tank 17 is equipped with a pressure limiter 19. The pressure limiter 19 is a pressure relief valve which is opened when the common rail pressure inside the common rail 11 exceeds a preset limit pressure, thus holding the common rail pressure inside the common rail 11 within the preset limit pressure. On the other hand, the common rail 11 is equipped with a pressure reducing valve 21. The pressure reducing valve 21 is opened by a valve open instruction signal given from the ECU 13, and rapidly releases the common rail pressure through the relief pipe 18. With the common rail 11 equipped with the pressure reducing valve 21, the ECU 13 can perform control so as to quickly reduce the common rail pressure to the pressure that matches the vehicle driving condition. There are cases where the pressure reducing valve 21 is not provided.

The piezo injectors 1 are provided one for each cylinder of the engine, and deliver fuel to the respective cylinders by injection; each piezo injector 1 is connected to the downstream end of a corresponding one of the plurality of injector pipes 16 branching off from the common rail 11, and delivers the high-pressure fuel accumulated in the common rail 11 to the corresponding cylinder by injection. The detailed structure will be described later. Any fuel leaking from the piezo injectors 1 is also returned to the fuel tank 17 through the relief pipe 18.

The supply pump 12 is a high-pressure fuel pump that supplies fuel under pressure to the common rail 11, and is equipped with a feed pump which draws the fuel in the fuel tank 17 into the supply pump 12; the supply pump 12 then compresses the fuel at high pressure and supplies the fuel under pressure to the common rail 11. The feed pump and the supply pump 12 are both driven via a common cam shaft 23. This cam shaft 23 is driven for rotation by the engine.

The supply pump 12 is also equipped with an SCV (Suction Control Valve) 24 for adjusting the opening of a fuel flow passage through which the fuel is introduced into a pressure chamber where the fuel is compressed at high pressure. The SCV 24 is a valve which, under the control of a pump driving signal from the ECU 13, adjusts the amount of fuel to be drawn into the pressure chamber and thus changes the amount of fuel to be fed under pressure into the common rail 11; by thus adjusting the amount of fuel to be fed under pressure into the common rail 11, the common rail pressure is adjusted. That is, by controlling the SCV 24, the ECU 13 can control the common rail pressure to the pressure that matches the vehicle driving condition.

Next, the piezo injector 1 will be described. One example of the piezo injector 1 is shown in cross section in FIG. 4, and its construction is depicted diagrammatically in FIGS. 5A and 5B. In the following description, the upper side refers to the upper side of each figure, and the lower side refers to the lower side of each figure. The piezo injector 1 has a substantially rod-like shape; its lower side passes through the wall of the engine combustion chamber and its lower end protrudes into the combustion chamber. The piezo injector 1 comprises a nozzle section 31, a three-way valve 32, a displacement magnifying means 33, and a piezo stack 4 in this order from the bottom to the top of the figure. The detailed structure of these components will be described in sequence below.

The nozzle section 31 is a part that controls the on/off operation of the high-pressure fuel injection, and includes a needle 7 slidably supported within a housing 34 (nozzle holder 35). A larger diameter portion 36 in the upper part of the needle 7 is slidably supported within the nozzle holder 35, while the cone-shaped lower end portion 37 of the needle 7 is held down against or drawn away from an annular seat 38 formed around the inner circumference of the lower end portion of the nozzle holder 35. High-pressure fuel is introduced into a space 39 surrounding the outer circumference of the lower portion of the needle 7 through a high-pressure passage 42 formed in the housing 34 (valve body 41 and nozzle holder 35), and the fuel is injected through an injection port 43 when the needle 7 is drawn away from it. The high-pressure fuel supplied into the space 39 surrounding the outer circumference of the lower portion of the needle 7 exerts a pressure on a step face 36a of the larger diameter portion 36 and thus acts to lift the needle 7 upward (in the direction moving away from the seat). On the other hand, a back pressure chamber 44 located above the larger diameter portion 36 is supplied with fuel from the high-pressure passage 42 through an in-orifice 45, and the high-pressure fuel supplied into the back pressure chamber 44 exerts a pressure on an upper face 36b of the larger diameter portion 36b and thus acts, together with a second return spring 46, to press the needle 7 downward (in the direction toward the seat).

The three-way valve 32 is a back pressure switching means for switching the back pressure chamber 44 between the high-pressure passage 42 and a low-pressure passage (leakage fuel passage) 47, and is constructed from a spool valve in the present embodiment. The three-way valve 32 constructed from the spool valve includes a spool (valve plug) 48 slidably supported within the housing 34 (valve body 41); when the spool 48 moves downward as shown in FIG. 5A, a back pressure communicating passage 25 communicating with the back pressure chamber 44 becomes connected with the low-pressure passage 47 through which leakage fuel is ejected, and the pressure inside the back pressure chamber 44 drops. As a result, the needle 7 is drawn away from the seat, allowing the fuel to be injected.

Conversely, when the spool 48 moves upward as shown in FIG. 5B, the back pressure communicating passage 25 communicating with the back pressure chamber 44 becomes connected with the high-pressure passage 42 through which the high-pressure fuel is supplied, and the pressure inside the back pressure chamber 44 rises. As a result, the needle 7 is held down against the seat, thus stopping the fuel injection. A third return spring 49 for urging the spool 48 upward is attached to the lower end of the spool 48.

The displacement magnifying means 33 is a means for magnifying the amount of expanding/contracting displacement of the piezo stack 4 (the amount of dimensional change in the stacking direction, that is, the amount of change in the up/down direction) and transmitting it to the spool 48 of the three-way valve 32, and comprises: a small-diameter piston 51 provided above the spool 48; the driving member 5 (in the present embodiment, a larger-diameter piston) which is directly driven by the piezo stack 4; and a displacement magnifying chamber 52 formed between the upper face of the small-diameter piston 51 and the lower face of the driving member 5.

The driving member 5 is slidably supported within the housing 34 (valve body 41). The driving member 5 is pressed against the piezo stack 4 by the first return spring 6, and is displaceable in up-down directions by an amount equal to the amount of contraction/expansion of the piezo stack 4. That is, the driving member 5 moves in the stacking direction (downward direction) by being directly driven with the expansion of the piezo stack 4.

When the piezo stack 4 expands in the stacking direction, the driving member 5 is caused to move downward, causing the spool 48 of the three-way valve 32 to move downward; as a result, the pressure inside the back pressure chamber 44 drops, allowing the fuel to be injected. Conversely, when the piezo stack 4 contracts in the stacking direction, the driving member 5 is caused to move upward, causing the spool 48 of the three-way valve 32 to move upward; as a result, the pressure inside the back pressure chamber 44 rises, thus shutting off the fuel injection.

The construction of the piezo stack 4 is well known in the art, one example of which will be described with reference to FIG. 6. The piezo stack 4 is constructed by stacking a large number of flat-plate piezo elements 3 which expand in the thickness direction when electrically charged. Each piezo element 3 comprises a piezoelectric body having a substantially plate shape and internal electrodes formed on opposite surfaces of the piezoelectric body, and a large number of such piezo elements 3 are stacked in the thickness direction to construct the piezo stack 4.

Two side electrodes 53 are formed on opposite side faces of the piezo stack 4. One of the side electrodes 53 is electrically connected to one internal electrode of each piezoelectric body, and the other side electrode 53 is electrically connected to the other internal electrode of each piezoelectric body. The inner portion of the side electrode 53 may be formed as a hard electrode 53a and the outer portion as a soft electrode 53b, as shown in FIG. 6, but alternatively, the entire electrode may be formed as the soft electrode 53b.

The two side electrodes 53 are respectively connected electrically to two energization terminals 54 that are formed passing through a fixed base 56 vertically as will be described later, and the piezo elements 3 in the piezo stack 4 are energized by applying a voltage to external connectors 54a (see FIG. 4) connected to the energization terminals 54. In the present embodiment, the piezo stack 4 is shown as comprising only the piezo elements 3; however, as an alternative structure, other elements such as electrically resistive heating elements which generate heat when energized may be inserted in suitable portions of the piezo stack 4.

The piezo stack 4 is housed in a sealed case to prevent contact with the fuel. The sealed case comprises a cylindrical bellows (see FIG. 4) which accommodates a stack case 55, fixed base (upper base) 56, and driving member 5, and which has a structure that does not hinder the vertical displacement of the driving member 5. The stack case 55 is a cylindrically shaped metal case that covers the outer circumference of the piezo stack 4 and that has an inner diameter slightly larger than the outer diameter of the piezo stack 4 to allow the piezo stack 4 accommodated therein to expand and contract in the vertical direction.

The fixed base 56 is a metal member comprising a larger diameter bottom portion 56a, a smaller diameter top portion 56b, and a tapered or sphered portion 56c connecting between them, and the larger diameter portion 56a is fitted into the upper end of the stack case 55 to hermetically close the upper end of the stack chamber. The fixed base 56 also acts as a member that contacts the upper end of the piezo stack 4 and restricts the vertical displacement of the upper end of the piezo stack 4.

On the other hand, the sealed case containing the piezo stack 4 is placed in an actuator chamber formed within the housing 34 (valve body 41) of the piezo injector 1, and the tapered portion 56c of the fixed base 56 is a member that contacts a tapered or sphered face 57 formed in the upper portion of the actuator chamber and restricts the vertical displacement of the upper end of the piezo stack 4 via the fixed base 56.

That is, the fixed base 56 that contacts the upper end of the piezo stack 4 and the valve body 41 that contacts the upper end of the fixed base 56 together correspond to the fixed member that accepts the expansion of the piezo stack 4 on the upper side of the piezo stack 4 (the side opposite from the driving member 5). The fixed base 56 and the valve body 41 that supports the fixed base 56 are each formed from a hard metal (stainless steel) having a Young's modulus of about 13 GPa, and are structured to firmly hold the upper end portion of the piezo stack 4 in a fixed position.

The controller 2 comprises the ECU 13 and EDU 14, as earlier mentioned. The ECU 13 is constructed from a computer of a known configuration comprising a CPU for performing control and arithmetic and logic operations, storage devices (memories such as ROM, RAM, SRAM, and EEPROM) for storing various programs and data, input circuitry, output circuitry, and power supply circuitry. The ECU 13 performs various arithmetic and logic operations based on sensor signals (engine parameters: signals responsive to the vehicle driving condition and engine operating condition).

Various sensors for detecting engine parameters, such as an accelerator pedal opening sensor for detecting accelerator pedal opening, an engine speed sensor for detecting engine speed in rpm and crankshaft angle, a coolant temperature sensor for detecting engine coolant temperature, and a common rail pressure sensor 58 for detecting common rail pressure, are connected to the ECU 13. The ECU 13 is equipped with a “charge/discharge control function (piezo injector control function)” for controlling the fuel injection operation of the piezo injector 1 and an “SCV control function” for controlling the opening of the SCV 24.

The charge/discharge control function is a function for controlling the charging/discharging to the piezo stack 4 with the timing that matches the current driving condition, and computes “injection mode” such as single injection or multiple injection, “injection start timing” for each injection, and “injection time (amount of injection)” for each injection based on a preloaded program and on various sensor signals (engine parameters) read into the controller 2 and controls the charging and discharging of the piezo stack 4 based on the thus computed injection mode, injection start timing, and injection time. More specifically, the charge/discharge control function is implemented by a control program that determines “charge start timing” for starting the injection at the injection start timing, while also determining “discharge start timing” from the injection time (the amount of injection), and supplies to a charge/discharge circuit 61 in the EDU 14 an “injection signal TQ” that lasts from the charge start timing to the discharge start timing.

The SCV control function is implemented by a control program that determines the target common rail pressure appropriate to the current vehicle driving condition, computes the SCV opening with which the actual common rail pressure detected by the common rail pressure sensor 58 becomes equal to the target common rail pressure, and supplies the thus computed “valve open signal (for example, a PWM signal)” to the SCV 24.

The charge/discharge circuit 61 will be described with reference to FIG. 7 which shows one example of the charge/discharge circuit 61 for the piezo stack 4. The charge/discharge circuit 61 comprises a DC power supply 62, a charge switch 63 for charging the piezo stack 4, a discharge switch 64 for discharging the piezo stack 4, a selector switch 65 for selecting the piezo stack 4 to be charged or discharged, an energy accumulating coil 66, and a plurality of free-wheeling diodes 67.

The DC power supply 62 comprises a DC/DC converter 69 for generating a DC voltage of several tens to several hundreds of volts from a vehicle-mounted battery 68, and a buffer capacitor 71 connected in parallel to the DC/DC converter 69. The buffer capacitor 71 has a relatively large capacitance so that a constant voltage value is maintained during the charging to the piezo stack 4.

The charge switch 63 is controlled on and off based on a charge signal (the on state of the injection signal TQ) supplied from the ECU 13. The discharge switch 64 is controlled on and off based on a discharge signal (the off state of the injection signal TQ) supplied from the ECU 13. The selector switch 65 also is controlled on and off by the ECU 13. The charge switch 63, the discharge switch 64, and the selector switch 65 may each be constructed from a mechanical relay switch or from a semiconductor switching device such as a MOSFET. The energy accumulating coil 66 is inserted in an energization line for electrically connecting the DC power supply 62 to the respective piezo stacks 4, and stores the electrical energy flowing through the energization line.

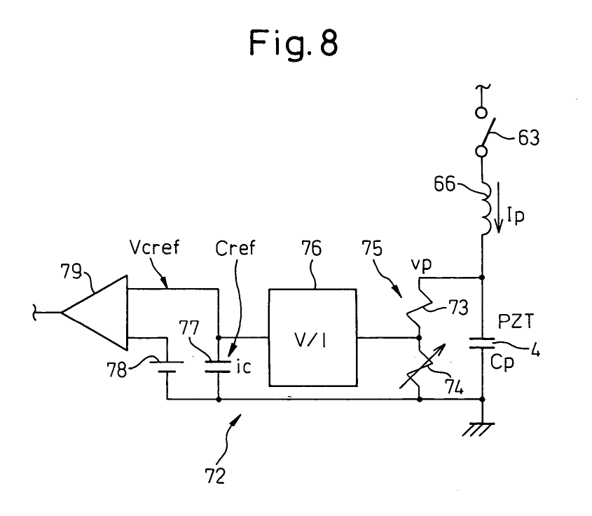

Next, a temperature compensation circuit 72 will be described. The charge/discharge circuit 61 is provided with the temperature compensation circuit 72 to ensure that a predetermined amount of energy will be stored in the piezo stack 4 by a charge operation despite variations in temperature, etc. One example of the temperature compensation circuit 72 is shown in FIG. 8. The temperature compensation circuit 72 comprises an integrating means for integrating the value of the voltage being applied to the piezo stack 4, and causes the charging to the piezo stack 4 to end when the integrated value reaches a predetermined value.

The integrating means comprises a monitoring means 75 using a fixed resistor 73 and a variable resistor 74 for reading the charge voltage value of the piezo stack 4, a voltage/current converting means 76 for converting the voltage value read by the monitoring means 75 into an electric current value, and a reference capacitor 77 which is charged by the output current of the voltage/current converting means 76. The reference capacitor 77 is formed, for example, from a capacitor of 5 to 12 μF having excellent temperature characteristics.

The temperature compensation circuit 72 further comprises a comparator 79 which outputs a “high” signal when the voltage charged in the reference capacitor 77 reaches a value (target charge voltage) preset by a reference voltage 78, and causes the charging to the piezo stack 4 to end based on the output of the comparator 79. That is, the temperature compensation circuit 72 converts the voltage applied to the piezo stack 4 into an electric current, integrates it with respect to time, and causes the charging to the piezo stack 4 to end when the integrated value reaches a predetermined value, that is, when the charge voltage of the piezo stack 4 reaches the target charge voltage.

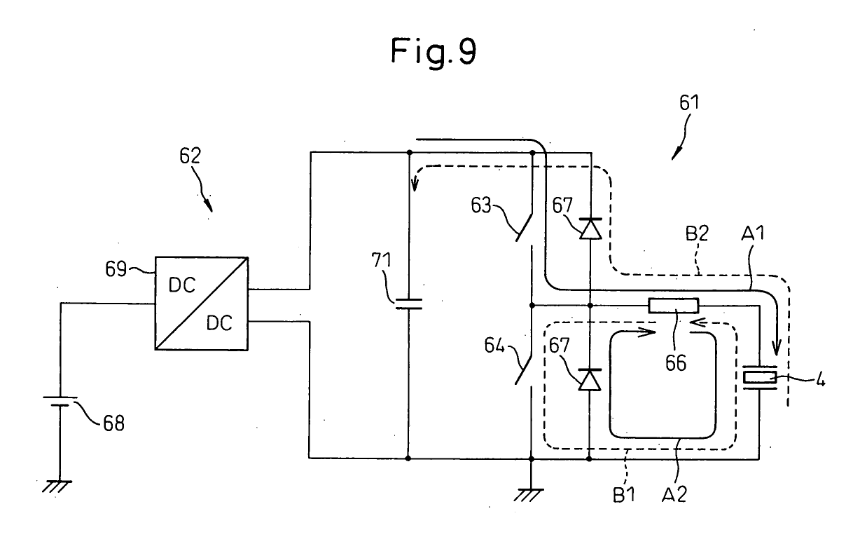

The basic operation for charging the piezo stack 4 will be described with reference to FIG. 9. When the injection signal TQ is applied (TQ is on) to the charge/discharge circuit 61 from the ECU 13, the charge switch 63 cycles on and off in the following manner. First, the charge switch 63 is turned on. Thereupon, the high voltage stored in the buffer capacitor 71 is supplied to the piezo stack 4 via the charge switch 63 and the energy accumulating coil 66, as indicated by a solid line A1 in FIG. 9. At this time, the piezo stack 4 is charged while, at the same time, energy is stored in the energy accumulating coil 66. The energizing current value of the piezo stack 4 is being monitored and, when the energizing current value of the piezo stack 4 reaches a predetermined current value (for example, 12 (A)), the charge switch 63 is turned off.

When the charge switch 63 is turned off, the condition shown by a solid line A2 in FIG. 9 results. That is, the energy stored in the energy accumulating coil 66 continues to be supplied to the piezo stack 4 via the free-wheeling diode 67, thus keeping charging the piezo stack 4. When the energizing current value of the piezo stack 4 being monitored drops to a predetermined current value (for example, 10 (A)), the charge switch 63 is turned on again, resuming the condition indicated by the solid line A1 in FIG. 9. Thereafter, the on-off operation of the charge switch 63 is repeated. With this operation, the piezo stack 4 is charged.

With the above charging operation, the charge voltage (integrated value) of the reference capacitor 77 rises. When this charge voltage (integrated value) reaches the preset target charge voltage (reference value), the comparator 79 outputs a “high” signal. Thereupon, the charge/discharge circuit 61 turns off the charge switch 63, and the charging to the piezo stack 4 thus ends. The value (target charge voltage) for ending the charging is suitably adjusted according to the capacitance of the reference capacitor 77, the set value of the variable resistor in the monitoring means, and the set value of the reference voltage 78.

The basic operation for discharging the piezo stack 4 will be described with reference to FIG. 9. When the injection signal TQ being applied to the charge/discharge circuit 61 from the ECU 13 stops (TQ is off), the discharge switch 64 cycles on and off in the following manner. First, the discharge switch 64 is turned on. Thereupon, the voltage stored in the piezo stack 4 flows through the energy accumulating coil 66 and the discharge switch 64, as indicated by a dashed line B1 in FIG. 9; that is, the electric energy stored in the piezo stack 4 is transferred to the energy accumulating coil 66, and the discharge of the piezo stack 4 progresses. The electric current value of the piezo stack 4 is being monitored and, when the electric current value of the piezo stack 4 reaches a predetermined current value (for example, 12 (A)), the discharge switch 64 is turned off.

When the discharge switch 64 is turned off, the condition shown by a dashed line B2 in FIG. 9 results. That is, the energy stored in the energy accumulating coil 66 is fed back to the buffer capacitor 71 via the free-wheeling diode 67. When the electric current value of the piezo stack 4 being monitored drops to a predetermined current value (for example, 10 (A)), the discharge switch 64 is turned on again, resuming the condition indicated by the dashed line B1 in FIG. 9. Thereafter, the on-off operation of the discharge switch 64 is repeated. With this operation, the piezo stack 4 is discharged.

A discharge temperature compensation circuit, similar to the charge temperature compensation circuit 72, as shown in FIG. 8, is provided in the charge/discharge circuit 61 in order to ensure that when a predetermined amount of electric energy is drawn from the piezo stack 4, the discharging of the piezo stack 4 ends regardless of whether the load of the piezo stack 4 varies due to variations in temperature, etc.

In the case of a fuel injection device to which the present invention is not applied, the device is only designed to start the injection when the target injection timing arrives, and no account has been taken of the voltage rise time t taken from the moment the charging to the piezo stack 4 is started until the piezo stack 4 is charged to the target charge voltage. Here, as previously described, as the structure is such that the driving member 5 is pressed against the piezo stack 4, there exists a combined resonant period T between the piezo stack 4 and the driving member 5. As a result, in an ideal (imaginary) condition in which external loads such as friction are not applied to the piezo stack 4 or the driving member 5, the rightwardly rising slope of the load varying with the combined resonant period T (the rightwardly rising slope of the resonant frequency) becomes the greatest at time 0.5 T±0.1 T. In each time chart, reference character A shows the change of the charge voltage, and reference character B shows the change of the load that the piezo stack 4 generates.

Here, when no account is taken of the voltage rise time t, there can occur cases where, after the charging to the piezo stack 4 is started, the end of the voltage rise time t is reached at time 0.5 T±0.1 T. In such cases, even when the charge voltage has reached the target charge voltage, and the voltage has stopped rising, the displacement occurring in the expanding direction due to the piezo stack 4 and the driving member 5 does not stop because of the presence of the combined resonance, and the expansion load continues to increase, resulting in the occurrence of a high load (a peak load due to overshooting). Thereafter, dips and peaks occur repetitively with the combined resonant period T. As such expansion and contraction force are applied directly to the piezo stack 4, the piezo stack 4 may eventually be damaged.

Further, even when the end timing of the voltage rise time t is not at 0.5 T±0.1 T, if the voltage rise time t is within 0.4 T, the voltage rise slope (the slope defining the charge voltage rise speed) becomes extremely steep, as a result of which the load rising slope also becomes extremely steep. Consequently, even when the charge voltage has reached the target charge voltage, and the voltage has stopped rising, the displacement occurring in the expanding direction due to the piezo stack 4 and the driving member 5 does not stop and, as described above, the expansion load continues to increase, resulting in the occurrence of a high load (a peak load due to overshooting). Thereafter, dips and peaks occur repetitively with the combined resonant period T. Since such expansion and contraction force are applied directly to the piezo stack 4, the piezo stack 4 may eventually be damaged.

To solve the above problem, the controller 2 of the first embodiment for controlling the charging and discharging of the piezo stack 4 performs first voltage rise control that satisfies the relation 0.6 T≦t, where t is the voltage rise time taken from the moment the charging to the piezo stack 4 is initiated until the piezo stack 4 is charged to the target charge voltage, and T is the combined resonant period of the piezo stack 4 and the driving member 5. That is, if the reciprocal of the combined resonant period T of the piezo stack 4 and the driving member 5 is, for example, 13.5 kHz, the first voltage rise control controls the voltage rise time t to 74.1 μsec×0.6 or longer, because 13.5 kHz translates into 74.1 μsec.

The following three examples are shown as specific techniques employed for controlling the voltage rise time t to 0.6 T or longer.

(1) The voltage rise time t is made equal to or longer than 0.6 T by making adjustments such as increasing the inductance/capacitance of the energy accumulating coil 66.

(2) When charging the piezo stack 4, the voltage rise time t is made equal to or longer than 0.6 T by reducing the predetermined current value at which the charge switch 63 is turned off after the charge switch 63 is turned on (for example, the predetermined current value at which the charge switch 63 is turned off during charging is reduced from 12 (A) to 10 (A)).

(3) When charging the piezo stack 4, the voltage rise time t is made equal to or longer than 0.6 T by reducing the predetermined current value at which the charge switch 63 is turned on after the charge switch 63 is turned off (for example, the predetermined current value at which the charge switch 63 is turned on during charging is reduced from 10 (A) to 8 (A)).

The above techniques (2) and (3) aim to reduce the voltage rise speed by making the off-time of the charge switch 63 longer. By using any one of the above techniques (1) to (3) singly or in a suitable combination, the voltage rise time t is made equal to or longer than 0.6 T, as shown by dashed lines A in FIGS. 1B and 1C. In this way, the voltage rise slope just before the end of the voltage rise time t becomes gentle, while preventing the timing at which the voltage charging to the piezo stack 4 ends (the end of the voltage rise time t) from overlapping with the timing at which the rightwardly rising slope of the load varying with the combined resonant period T becomes the greatest.

According to the fuel injection device of the first embodiment, as the voltage rise time t is made equal to or longer than 0.6 T as described above, the timing at which the voltage charging ends does not overlap with the timing at which the rightwardly rising slope of the load varying with the combined resonant period T becomes the greatest. Further, making the voltage rise time t equal to or longer than 0.6 T has the effect of relaxing the voltage rise slope. As a result, the high load (a peak due to overshooting) occurring in the piezo stack 4 after the charge voltage has reached the target charge voltage can be suppressed and, at the same time, expansion and contraction force repetitively occurring thereafter can also be suppressed.

As specific examples, FIG. 1B shows the load variation occurring in the piezo stack 4 when the voltage rise time t is 1.0 T (i.e., t=T), and FIG. 1C shows the load variation occurring in the piezo stack 4 when the voltage rise time t is 1.5 T (i.e., t=1.5 T).

In the case of t=T shown in FIG. 1B, the time at which the charge voltage reaches the target charge voltage and the voltage charging ends coincides with the time at which the displacement in the expanding direction due to the combined resonant period T of the piezo stack 4 and the driving member 5 stops. That is, when the end of the voltage rise time t is reached, the load varying with the combined resonant period T reaches top dead center. This serves to suppress the expansion and contraction force occurring after the charge voltage has reached the target charge voltage.

In the case of t=1.5 T shown in FIG. 1C, when the charge voltage reaches the target charge voltage and the voltage charging ends, the rightwardly rising slope of the load varying with the combined resonant period T becomes the greatest. However, since the voltage rise time t is increased to 1.5 T, and the voltage rise slope (the slope defining the charge voltage rise speed) is gentle, the rightwardly rising slope of the sine wave varying at every combined resonant period T becomes gentle compared with the case where the voltage rise time t is 0.5 T. As a result, the expansion and contraction force occurring after the charge voltage has reached the target charge voltage can be well suppressed, compared with the case where the voltage rise time t is 0.5 T.

In this way, according to the fuel injection device of the first embodiment, since the expansion and contraction force occurring in the piezo stack 4 can be suppressed, the long-term reliability of the piezo stack 4 improves, which serves to increase the durability of the piezo injector 1 and enhance the reliability of the fuel injection device.

### SECOND EMBODIMENT

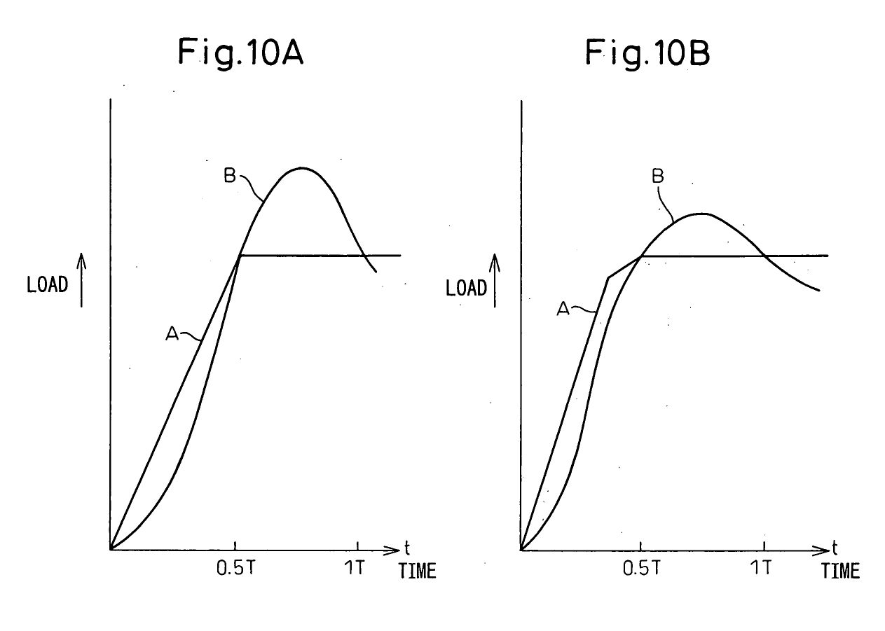

A second embodiment according to the present invention will be described below with reference to FIGS. 10A and 10B. In each embodiment hereinafter given, the same reference characters as those in the first embodiment indicate parts having the same functions. The first embodiment described above has shown examples in which the expansion and contraction force occurring after the charge voltage has reached the target charge voltage are suppressed by making the voltage rise time t equal to or longer than 0.6T. In contrast, the second embodiment aims to suppress the expansion and contraction force occurring after the charge voltage has reached the target charge voltage, even when the voltage rise time t is shorter than 0.6 T.

The controller 2 of the second embodiment performs second voltage rise control in which, when 0.25 T≦t<0.6T, the average voltage rise speed during the period from 0.5 t to 1 t is made slower than the average voltage rise speed during the period from the initiation of the charging to the piezo stack 4 to 0.5 t. That is, the voltage rise speed immediately before reaching the end of the voltage rise time t is made slower. A specific example will be described with reference to FIG. 10B. In this example, t=0.5 T, but the voltage rise slope from 0.4 to 0.5 T is made less steep than the voltage rise slope from 0 to 0.4 T.

The following two examples are shown as specific techniques employed for reducing the voltage rise speed during the period immediately before the end of the voltage charging.

(1) When charging the piezo stack 4, the voltage rise speed is made slower for the period immediately before the end of the voltage charging by reducing the predetermined current value at which the charge switch 63 is turned off after the charge switch 63 is turned on (for example, the predetermined current value at which the charge switch 63 is turned off during charging is reduced from 12 (A) to 10 (A)).

(2) When charging the piezo stack 4, the voltage rise speed is made slower for the period immediately before the end of the voltage charging by reducing the predetermined current value at which the charge switch 63 is turned on after the charge switch 63 is turned off (for example, the predetermined current value at which the charge switch 63 is turned on during charging is reduced from 10 (A) to 8 (A)).

The above techniques (1) and (2) aim to reduce the voltage rise speed by making the off-time of the charge switch 63 longer. By using either one of the above techniques (1) and (2) or a combination thereof, the voltage rise speed during the period immediately before the end of the voltage charging can be made slower as shown by the solid line A in the figure.

With the above arrangement, even when the end timing of the voltage rise time t is 0.5 T±0.1 T, or when the voltage rise time t is within 0.4 T, the voltage rise slope at the end of the voltage rise time t becomes gentle. As a result, the high load (a peak due to overshooting) occurring after the charge voltage has reached the target charge voltage can be suppressed and, at the same time, repetitively occurring peaks and dips thereafter can also be suppressed. In this way, as the expansion and contraction force occurring in the piezo stack 4 can be suppressed, the long-term reliability of the piezo stack 4 improves, which serves to increase the durability of the piezo injector 1 and enhance the reliability of the fuel injection device.

### THIRD EMBODIMENT

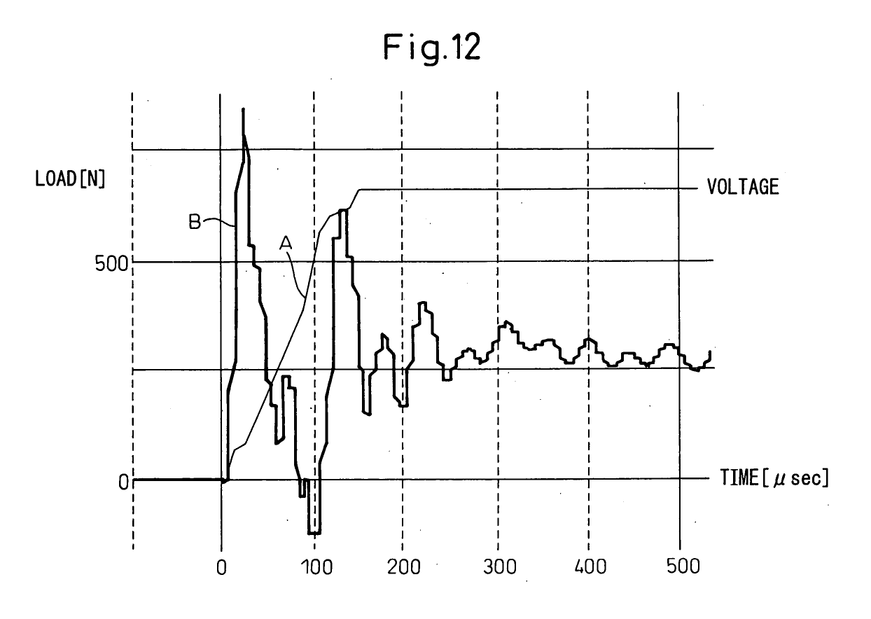

A third embodiment according to the present invention will be described below with reference to FIGS. 11 and 12. The piezo stack 4 and the driving member 5 are subjected to external loads such as friction during expansion. When the charging is started, the piezo stack 4 begins to generate an expansion load. After the piezo stack 4 begins to expand, the expansion load reaches a maximum the instant the driving member 5 begins to move. To describe a specific example with reference to FIG. 11, a load variation peak occurs in the piezo stack 4 at a time instant 21 (μs) after the initiation of the charging to the piezo stack 4. Immediately after the occurrence of the load variation peak, a contraction occurs in the direction in which the expansion contracts; thereafter, dips and peaks due to overshooting occur repetitively. As such expansion and contraction force are applied directly to the piezo stack 4, the piezo stack 4 may eventually be damaged.

The fuel injection device of the third embodiment employs the following means to solve the above problem. The controller 2 of the third embodiment performs third voltage rise control in which the voltage rise speed during the period within ±0.1 T of a load variation peak (minimum value at the load peak) occurring in the piezo stack 4 within the voltage rise time t from the initiation of the charging to the piezo stack 4 until the piezo stack 4 is charged to the target charge voltage is made slower than the voltage rise speed during the other periods, and/or the voltage rise speed during the period within ±0.1 T of a load variation dip (minimum value at the load dip) occurring in the piezo stack 4 is made faster than the voltage rise speed during the other periods.

A specific example will be described with reference to FIG. 12. In FIG. 12, it is assumed that the combined resonant period T of the piezo injector 1 is 135.9 (μs) and that the voltage rise time t is 150 (μs) as an example. After the charging to the piezo stack 4 is started, a load variation peak occurs at the instant (21 (μs)) that the driving member 5 begins to move, and thereafter, multiple resonances occur, generating expansion and contraction force. A peak load due to the combined resonant period T is also generated in the vicinity of 135.9 (μs).

Then, the controller 2 performs control to make the voltage rise speed in the period within ±0.1 T of the occurrence of the peak slower than the voltage rise speed in the other periods and/or make the voltage rise speed in the period within ±0.1 T of the occurrence of the dip faster than the voltage rise speed in the other periods. A description will be given of specific techniques for making the voltage rise speed in the period within ±0.1 T of the occurrence of the peak slower than the voltage rise speed in the other periods and/or making the voltage rise speed in the period within ±0.1 T of the occurrence of the dip faster than the voltage rise speed in the other periods. Peaks and dips that occur during the charging to the piezo stack 4 depend on the design of the piezo injector 1, and the peak and dip occurrence times can be predicted, for example, by reading data in advance. Then, the peak and dip occurrence times are written to a map or the like in the ECU 13, and the control for making the voltage rise speed in the period within ±0.1 T of the occurrence of the peak slower than the voltage rise speed in the other periods and the control for making the voltage rise speed in the period within ±0.1 T of the occurrence of the dip faster than the voltage rise speed in the other periods are performed after the start of charging.

The following two examples are shown as specific techniques employed for setting the voltage rise speed in the period within ±0.1 T of the occurrence of the peak or dip differently than the voltage rise speed in the other periods.

(1) When charging the piezo stack 4, the voltage rise speed is made slower for the period within ±0.1 T of the occurrence of the peak by reducing the predetermined current value at which the charge switch 63 is turned off after the charge switch 63 is turned on (for example, the predetermined current value at which the charge switch 63 is turned off during charging is reduced from 12 (A: ampere) to 10 (A)). The voltage rise speed is made faster for the period within ±0.1 T of the occurrence of the dip by increasing the predetermined current value at which the charge switch 63 is turned off after the charge switch 63 is turned on (for example, the predetermined current value at which the charge switch 63 is turned off during charging is increased from 12 (A) to 14 (A)).

(2) When charging the piezo stack 4, the voltage rise speed is made slower for the period within ±0.1 T of the occurrence of the peak by reducing the predetermined current value at which the charge switch 63 is turned on after the charge switch 63 is turned off (for example, the predetermined current value at which the charge switch 63 is turned on during charging is reduced from 10 (A) to 8 (A)). The voltage rise speed is made faster for the period within ±0.1 T of the occurrence of the dip by increasing the predetermined current value at which the charge switch 63 is turned on after the charge switch 63 is turned off (for example, the predetermined current value at which the charge switch 63 is turned on during charging is increased from 10 (A) to 11 (A)).

The above techniques (1) and (2) aim to reduce the voltage rise speed by making the off-time of the charge switch 63 longer and to increase the voltage rise speed by making the on-time of the charge switch 63 longer. By using either one of the above techniques (1) and (2) or a combination thereof, the voltage rise speed in the period within ±0.1 T of the occurrence of the peak can be made slower than the voltage rise speed in the other periods, as shown by the solid line A in FIG. 12. Further, the voltage rise speed in the period within ±0.1 T of the occurrence of the dip can be made faster than the voltage rise speed in the other periods.

The third embodiment has shown examples in which the voltage rise speed is reduced based on the values (peak and dip occurrence times) written to the map, but alternatively, the load generated by the piezo stack 4 may be detected using a load sensor or the like, and the voltage rise speed may be corrected by feedback based on the generated load.

In the third embodiment, as the voltage rise speed before and after a peak is made slower and/or the voltage rise speed before and after a dip is made faster by using the above-described techniques, the peak load that occurs the instant the driving member 5 begins to move and the dip and peak loads that occur thereafter can be suppressed. As a result, the long-term reliability of the piezo stack 4 improves, which serves to increase the durability of the piezo injector 1 and to enhance the reliability of the fuel injection device.

### FOURTH EMBODIMENT

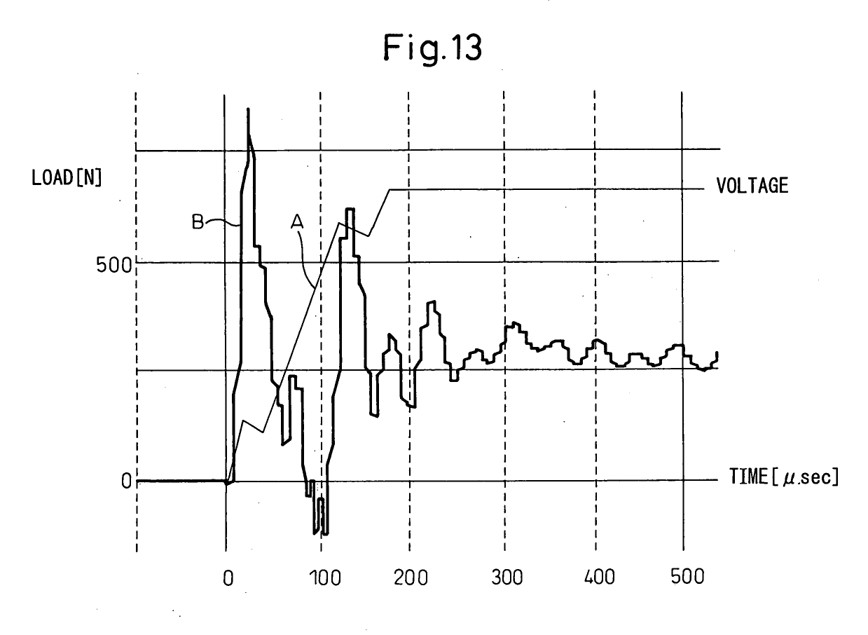

A fourth embodiment according to the present invention will be described below with reference to FIG. 13. The third embodiment described above has shown examples in which the occurrence of expansion and contraction force is suppressed by making the voltage rise speed before and after a peak slower and/or by making the voltage rise speed before and after a dip faster. In contrast, the controller 2 of the fourth embodiment performs fourth voltage rise control in which the voltage being applied during the voltage rise time t is reduced for the period within ±0.1 T of the load variation peak occurring in the piezo stack 4.

A specific example will be described with reference to FIG. 13. In FIG. 13, as in the third embodiment, it is assumed that the combined resonant period T of the piezo injector 1 is 135.9 (μs) and that the voltage rise time t is 150 (μs) as an example. After the charging to the piezo stack 4 is started, a load variation peak occurs at the instant (21 (μs)) that the driving member 5 begins to move, and thereafter, multiple resonances occur, generating expansion and contraction force. A peak load due to the combined resonant period T is also generated in the vicinity of 135.9 (μs).

Then, the controller 2 performs control to reduce the voltage to be applied during the period within ±0.1 T of the occurrence of the peak. A specific technique for reducing the voltage to be applied during the period within ±0.1 T of the occurrence of the peak will be described below.

As described in the foregoing third embodiment, peaks that occur during the charging to the piezo stack 4 depend on the design of the piezo injector 1, and the peak occurrence times can be predicted, for example, by reading data in advance. Then, the peak occurrence times are written to a map or the like in the ECU 13, and the control for reducing the voltage to be applied during the period within ±0.1 T of the occurrence of the peak is performed after the start of charging.

In one specific example of the technique for reducing the voltage to be applied during the period within ±0.1 T of the occurrence of the peak, the charge operation is stopped for the period within ±0.1 T of the occurrence of the peak during the charging to the piezo stack 4, and instead, a discharge operation is performed. By so doing, the charge voltage of the piezo stack 4 can be reduced during the period within ±0.1 T of the occurrence of the peak.

The fourth embodiment has shown an example in which the charge voltage is reduced based on the values (peak occurrence times) written to the map, but alternatively, the load generated by the piezo stack 4 may be detected using a load sensor or the like, and the charge voltage may be corrected by feedback based on the generated load.

In the fourth embodiment, as the charge voltage before and after a peak is reduced by using the above-described technique, the peak load that occurs the instant the driving member 5 begins to move and the peak loads that occur thereafter can be suppressed. Further, by suppressing the peak loads, dip loads that immediately follow them can also be suppressed. As a result, the long-term reliability of the piezo stack 4 improves, which serves to increase the durability of the piezo injector 1 and enhance the reliability of the fuel injection device.

### FIFTH EMBODIMENT

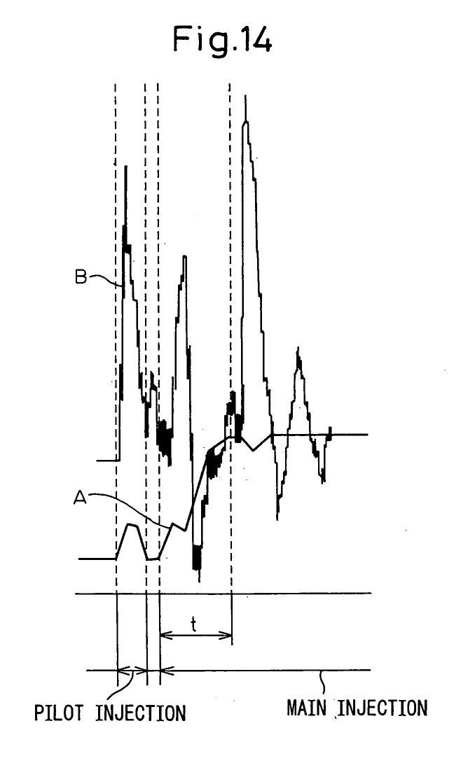

A fifth embodiment according to the present invention will be described below with reference to FIG. 14. The fuel injection device may perform multiple injections in which injections are repeated at short intervals. To give a specific example, as shown in FIG. 14, pilot injection with a short injection time is performed and is immediately followed by main injection with a long injection time. In this case, resonance that occurred during the pilot injection may extend as residual resonance into the voltage rise time t for the main injection that follows. If the residual resonance extends into the voltage rise time t for the main injection, the load variation due to the residual resonance will be superimposed on the load variation due to the rising voltage, resulting in the occurrence of a high load, and the piezo stack 4 may eventually be damaged.

On the other hand, if the residual resonance extends into the voltage rise time t for the main injection, and the load increases, the rise timing of the expansion load is advanced and, as a result, the injection timing may occur earlier. Conversely, if the residual resonance extends into the voltage rise time t for the main injection, and the load decreases, the expansion of the piezo stack is restricted, and as a result, the injection timing may be delayed.

To solve the above problem, the fuel injection device of the fifth embodiment employs the following means. That is, if there is any residual resonance from the preceding injection, the controller 2 of the fifth embodiment performs a fifth voltage rise control in which a voltage opposite in phase to the load variation occurring due to the residual resonance within the voltage rise time t is applied to the piezo stack 4. More specifically, the control is performed in the following manner; that is, as shown by a solid line A in FIG. 14, (1) when the load associated with the residual resonance increases, the charge voltage of the piezo stack 4 is reduced by, for example, performing a discharge operation as in the fourth embodiment, and (2) conversely, when the load associated with the residual resonance decreases, the rising slope of the charge voltage of the piezo stack 4 is increased, for example, by performing rapid charging.

The residual resonance occurring within the voltage rise time t depends on the energization start timing for the pilot injection (pre-injection) and the design of the piezo injector 1, and can be predicted, for example, by reading data in advance. Therefore, the ECU 13 computes the residual resonance expected to occur within the voltage rise time t, based on the energization start timing for the pilot injection (pre-injection) and the peak/dip occurrence data written to a map or the like in the ECU 13, and performs control so that a voltage opposite in phase to the load variation occurring within the voltage rise time t due to the residual resonance is applied to the piezo stack 4.

Further, the controller 2 of the fifth embodiment performs sixth voltage rise control in which a voltage opposite in phase to the load variation occurring due to the residual resonance is applied to the piezo stack 4 even after the voltage rise time t has elapsed. More specifically, the control is performed in the following manner; that is, as shown by a solid line B in FIG. 14, after the voltage rise time t has elapsed, (1) when the load associated with the residual resonance increases, the charge voltage of the piezo stack 4 is reduced, for example, by performing a discharge operation, and (2) conversely, when the load associated with the residual resonance decreases, the charge voltage of the piezo stack 4 is increased, for example, by performing a charge operation.

The fifth embodiment has shown examples in which the influence of the residual resonance is compensated for based on the energization start timing for the pre-injection and the values (peak and dip occurrence times) drawn to the map but, alternatively, the load generated by the piezo stack 4 may be detected using a load sensor or the like, and the charge voltage may be corrected by feedback based on the generated load.

In the fifth embodiment, when the load associated with the residual resonance increases, the voltage rise slope is made negative by applying a voltage of opposite phase in accordance with the above-described technique; therefore, the load increasing speed is slowed, and the occurrence of a high load can be suppressed. As a result, the long-term reliability of the piezo stack 4 is improved, which serves to increase the durability of the piezo injector 1 and enhance the reliability of the fuel injection device.

On the other hand, when the load associated with the residual resonance increases within the voltage rise time t, the voltage rise slope is made negative to slow the load increasing speed; this serves to avoid the problem that the injection timing occurs earlier. Conversely, when the load associated with the residual resonance decreases within the voltage rise time t, the voltage rise slope is increased, thereby avoiding a situation where the expansion of the piezo stack 4 is restricted; this serves to avoid the problem that the injection timing delays.

### SIXTH EMBODIMENT

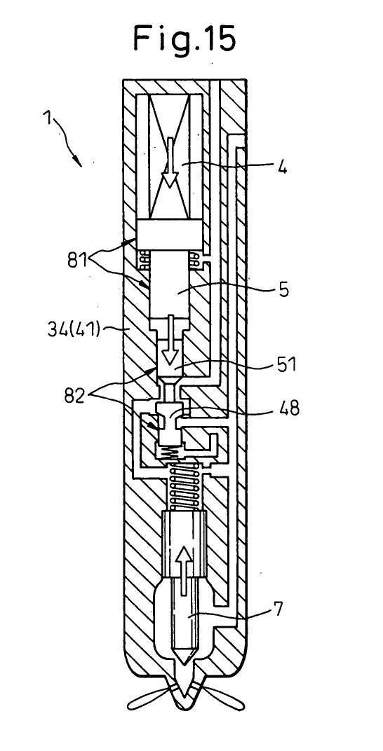

Sixth embodiment according to the present invention will be described with reference to FIG. 15. As previously described in the third embodiment, when the charging to the piezo stack 4 is started, the piezo stack 4 begins to expand, and thereafter, the load reaches a maximum the instant the driving member 5 begins to move. As this maximum load is directly applied to the piezo stack 4, the piezo stack 4 may eventually be damaged.

In the piezo injector 1 of the sixth embodiment, a first friction coefficient reducing means 81 for reducing friction coefficient is provided in a portion where the driving member 5 contacts a first slidable supporting member (valve body 41, etc.) that slidably supports the driving member 5. Further, in the piezo injector 1 of the sixth embodiment, as the ease of movement of the driving member 5 depends on the ease of movement of the small-diameter piston 51, a second friction coefficient reducing means 82 for reducing friction coefficient is provided in a portion where the small-diameter piston 51 contacts a second slidable supporting member (valve body 41, etc.) that slidably supports the small-diameter piston 51.

One example of the first and second friction coefficient reducing means 81 and 82 will be described below. The first and second friction coefficient reducing means 81 and 82 are means for improving the slidability of the driving member 5 and the small-diameter piston 51, respectively; this is accomplished by (1) mirror-finishing the sliding faces of the driving member 5 and the small-diameter piston 51, (2) mirror-finishing the sliding faces of the first and second slidable supporting members (valve body 41, etc.), (3) chamfering the corners (edges) of the driving member 5 and the small-diameter piston 51, (4) making the thermal expansion coefficient of the driving member 5 the same as that of the first slidable holding member (valve body 41, etc.) (for example, by forming them from stainless steel) in order to reduce variations in the sliding clearance of the driving member 5, and (5) making the thermal expansion coefficient of the small-diameter piston 51 the same as that of the second slidable holding member (valve body 41, etc.) (for example, by forming them from stainless steel) in order to reduce variations in the sliding clearance of the small-diameter piston 51. By employing one of the above (1) to (5) or by suitably combining them, the sixth embodiment improves the slidability of the driving member 5 and the small-diameter piston 51.

With the sixth embodiment, it becomes possible to suppress the peak load that occurs the instant the driving member 5 begins to move after the piezo stack 4 began to expand. Further, it also becomes possible to suppress the peak load that occurs the instant the small-diameter piston 51 begins to move. By thus suppressing the peak load applied to the piezo stack 4, the long-term reliability of the piezo stack 4 is improved, which serves to increase the durability of the piezo injector 1 and enhance the reliability of the fuel injection device.

### SEVENTH EMBODIMENT

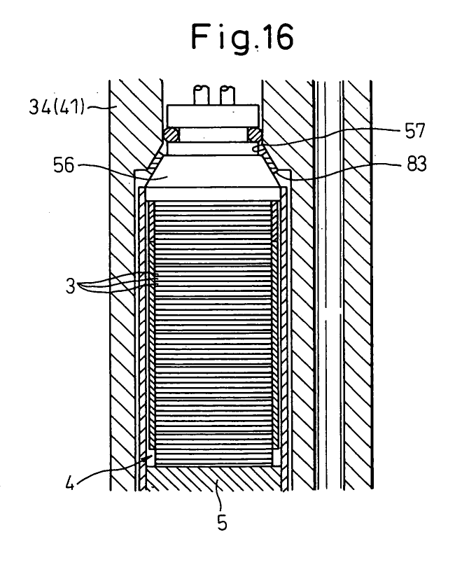

A seventh embodiment according to the present invention will be described below with reference to FIG. 16. As disclosed in the previously described first embodiment, the fixed base 56 that contacts the upper end of the piezo stack 4 and the housing 34 (valve body 41) that contacts the upper end of the fixed base 56 together correspond to the fixed member that accepts the expansion of the piezo stack 4 on the upper side of the piezo stack 4 (the side opposite from the driving member 5). The fixed base 56 and the valve body 41 that supports the fixed base 56 are each formed from a hard metal (stainless steel) having a Young's modulus of about 13 GPa, and are structured to firmly hold the upper end portion of the piezo stack 4 in a fixed position.

When electrically charging the piezo stack 4, one end of the expansion load occurring in the piezo stack 4 is transmitted to the driving member 5, but the other end of the expansion load occurring in the piezo stack 4 is accepted by the fixed member (the fixed base 56 and the valve body 41 supporting the fixed base 56). Here, the load occurring in the driving member 5 side of the piezo stack 4 is relieved as the driving member 5 moves. However, at the upper end of the piezo stack 4, the load is not released to the outside because the upper end is rigidly held by the fixed member. As a result, the piezo elements 3 in the upper portion of the piezo stack 4 (especially, the uppermost piezo element 3) are subjected to a large stress. Therefore, the piezo elements 3 located nearer to the fixed member (especially, the piezo element 3 nearest to the fixed member) are prone to damage, and thus the long-term reliability of the piezo stack 4 drops.

To solve the above problem, in the piezo injector 1 of the seventh embodiment, a low-rigidity portion whose rigidity is lower than the rigidity of the fixed member is provided between the piezo stack 4 and the fixed member that accepts the expansion of the piezo stack 4. More specifically, in the seventh embodiment, a low-rigidity member (for example, a copper washer or the like) 83 having a Young's modulus of 10 GPa or less is interposed as the low-rigidity portion between the fixed base 56 and the valve body 41. In the example shown in the seventh embodiment, the low-rigidity member 83 as the low-rigidity portion is installed between the fixed base 56 and the valve body 41, but instead, the low-rigidity member 83 may be installed between the fixed base 56 and the upper end of the piezo stack 4.

In the seventh embodiment, the load occurring in the fixed upper side of the piezo stack 4 is relieved as the low-rigidity member 83 deforms. This serves to prevent damage from being caused to the piezo elements 3 in the upper portion of the piezo stack 4 (especially, the uppermost one), and to enhance the long-term reliability of the piezo stack 4; as a result, the durability of the piezo injector 1 increases, enhancing the reliability of the fuel injection device.

### EIGHTH EMBODIMENT

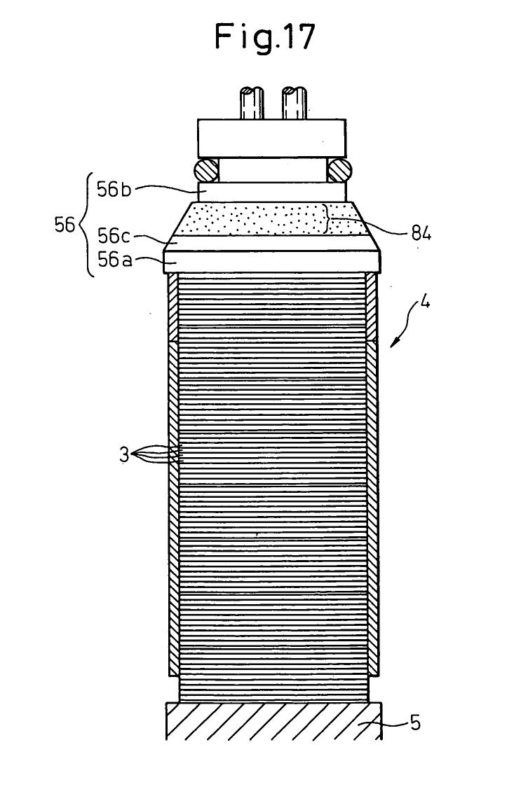

An eighth embodiment according to the present invention will be described below with reference to FIG. 17. The low-rigidity portion of the eighth embodiment is provided on a face where the fixed member accepts the expansion of the piezo stack 4, and is formed as a roughened surface 84 having a surface roughness of 1.6 Z or larger and a Young's modulus of 10 GPa or less. More specifically, in the eighth embodiment, either the contact portion of the housing 34 or the contact portion of the fixed member where one contacts the other (to be more specific, either the tapered or sphered portion 56c or the tapered face 57) is roughened, and the portion that supports the fixed base 56 is chosen to have a Young's modulus of 10 GPa or less. In the example of FIG. 17, the roughened surface 84 is provided on the tapered portion 56c.

The eighth embodiment offers the same effect as that achieved in the seventh embodiment. Further, since there is no need to provide a separate member (low-rigidity member 83) as in the seventh embodiment, the piezo injector 1 can be assembled more easily.

### NINTH EMBODIMENT

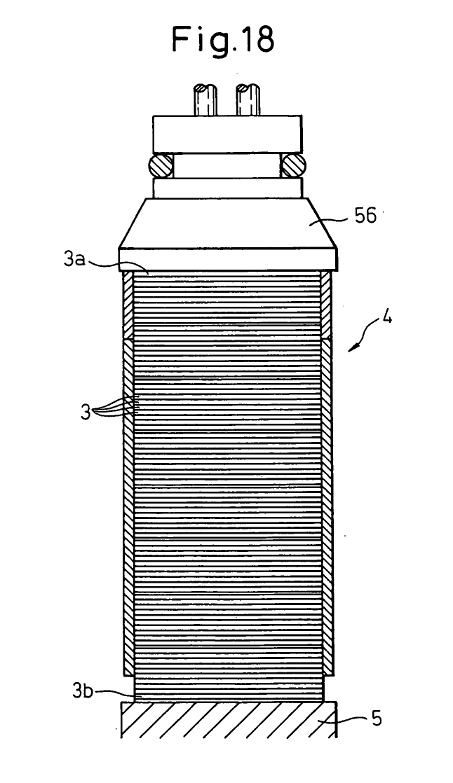

A ninth embodiment according to the present invention will be described below with reference to FIG. 18. FIG. 18 given here is an explanatory diagram common to the ninth to 11th embodiments hereinafter described. In the piezo injector 1 of the ninth embodiment, the uppermost piezo element 3a in the piezo stack 4 (of the piezo elements 3 forming the piezo stack 4, the piezo element 3 located at the farthest end from the driving member 5) is chosen to have a structure that reduces internal stress compared with the lowermost piezo element 3b (located at the end nearest to the driving member 5). More specifically, the diameter of the uppermost piezo element 3a is made larger (not shown in FIG. 18) than the diameter of the lowermost piezo element 3b to reduce the internal stress of the uppermost piezo element 3a. Further specifically, the diameter of the uppermost piezo element 3a is made 3% or more larger than the diameter of the lowermost piezo element 3b.

According to the ninth embodiment, as the load stress acting on the uppermost piezo element 3a in the piezo stack 4 is relieved by the presence of the uppermost piezo element 3a having the larger diameter, the uppermost piezo element 3a can be prevented from being damaged. As a result, the long-term reliability of the piezo stack 4 improves, increasing the durability of the piezo injector 1 and thus enhancing the reliability of the fuel injection device.

### 10TH EMBODIMENT

A 10th embodiment according to the present invention will be described below with reference to FIG. 18. The foregoing ninth embodiment has shown an example in which the internal stress is reduced by increasing the diameter of the uppermost piezo element 3a in the piezo stack 4 (of the piezo elements 3 forming the piezo stack 4, the piezo element 3 located at the farthest end from the driving member 5). By contrast, in the 10th embodiment, the thickness of the uppermost piezo element 3a in the piezo stack 4 is made greater than the thickness of the lowermost piezo element 3b to reduce the internal stress of the uppermost piezo element 3a. More specifically, the thickness of the uppermost piezo element 3a is made 3% or more greater than the thickness of the lowermost piezo element 3b.

According to the 10th embodiment, as the load stress acting on the uppermost piezo element 3a in the piezo stack 4 is relieved by the presence of the uppermost piezo element 3a having the greater thickness, the uppermost piezo element 3a can be prevented from being damaged. As a result, the long-term reliability of the piezo stack 4 is improved, increasing the durability of the piezo injector 1 and thus enhancing the reliability of the fuel injection device.

### 11TH EMBODIMENT

An 11th embodiment according to the present invention will be described below with reference to FIG. 18. The above ninth and tenth embodiments have each been shown as an example in which, of the piezo elements 3 forming the piezo stack 4, the internal stress of the uppermost piezo element 3a (the piezo element 3 located at the farthest end from the driving member 5) is reduced. By contrast, in the 11th embodiment, of the piezo elements 3 forming the piezo stack 4, the device strength of the uppermost piezo element 3a is made greater than that of the lowermost piezo element 3b. More specifically, the piezoelectric body forming the uppermost piezo element 3a is sintered more carefully than the piezoelectric bodies forming the other piezo elements 3, thereby increasing the device strength of the uppermost piezo element 3a. More specifically, the device strength of the uppermost piezo element 3a is made 10% or more greater than the device strength of the lowermost piezo element 3b.

According to the 11th embodiment, as the uppermost piezo element 3a is made to have a greater device strength than the other piezo elements forming the piezo stack 4, the uppermost piezo element 3a can be prevented from being damaged. As a result, the long-term reliability of the piezo stack 4 is improved, increasing the durability of the piezo injector 1 and thus enhancing the reliability of the fuel injection device.

### 12TH EMBODIMENT

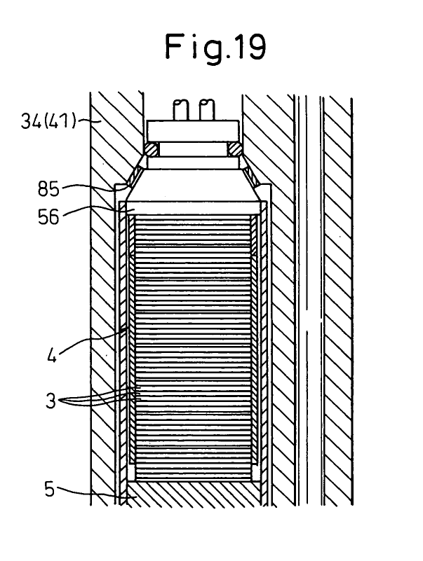

A 12th embodiment according to the present invention will be described below with reference to FIG. 19. Expansion and contraction force occur in the piezo stack 4 due to resonance, the driving of the driving member 5, and the movement of the small-diameter piston 51. The piezo elements 3 forming the piezo stack 4 are sensitive to impact, and may be damaged not only when a high load is applied as earlier described, but also when an abrupt tensile load is applied. That is, an abrupt dip load occurring in the piezo stack 4 can lead to a degradation of the long-term reliability of the piezo stack 4.

When electrically charging the piezo stack 4, one end of the expansion load occurring in the piezo stack 4 is transmitted to the driving member 5, but the other end of the expansion load occurring in the piezo stack 4 is accepted by the fixed member (the fixed base 56 and the valve body 41 supporting the fixed base 56). Considering this, in the 12th embodiment, a resilient member 85 which applies a compressing force to the piezo stack 4 is interposed between the piezo stack 4 and the fixed member (the fixed base 56 and the valve body 41 supporting the fixed base 56) that accepts the expansion of the piezo stack 4.

More specifically, in the 12th embodiment, a spring member (for example, a wave washer) is interposed as the resilient member 85 between the fixed base 56 and the valve body 41. In the example shown in the 12th embodiment, the resilient member 85 is installed between the fixed base 56 and the valve body 41, but instead, the resilient member 85 may be installed between the fixed base 56 and the upper end of the piezo stack 4.

According to the 12th embodiment, if a dip load causing an abrupt drop in the applied load occurs in the piezo stack 4, the dip load causing an abrupt drop in the applied load is absorbed by the resilient member 85, avoiding the problem that an abrupt drop in the load (an abrupt tensile load) is caused to the piezo stack 4. By thus suppressing the dip load applied to the piezo stack 4, the long-term reliability of the piezo stack 4 improves, which serves to increase the durability of the piezo injector 1 and enhance the reliability of the fuel injection device.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications and the combination of some embodiments are intended to be included within the scope of this invention.

What is claimed is:

1. A fuel injection device for an internal combustion engine, comprising:
a piezo injector comprising a piezo stack which, when electrically charged, generates an expansion in a direction in which piezo elements are stacked, and a driving member which moves in said stacking direction by being directly driven with the expansion of said piezo stack, wherein said piezo injector performs fuel injection by causing said driving member to move in said stacking direction with the expansion of said piezo stack; and
a controller for controlling charging and discharging of said piezo stack, wherein
said controller performs a first voltage rise control that satisfies the relation
0.6 T≦t
where t is a voltage rise time taken from the moment the charging of said piezo stack is initiated until said piezo stack is charged to a target charge voltage, and T is a combined resonant period of said piezo stack and said driving member.

2. A fuel injection device for an internal combustion engine, comprising:
a piezo injector comprising a piezo stack which, when electrically charged, generates an expansion in a direction in which piezo elements are stacked, and a driving member which moves in said stacking direction by being directly driven with the expansion of said piezo stack, wherein said piezo injector performs fuel injection by causing said driving member to move in said stacking direction with the expansion of said piezo stack; and
a controller for controlling charging and discharging of said piezo stack, wherein
letting t denote a voltage rise time taken from the moment the charging of said piezo stack is initiated until said piezo stack is charged to a target charge voltage, and T denote a combined resonant period of said piezo stack and said driving member, then when 0.25 T≦t<0.6 T
said controller performs a second voltage rise control in which average voltage rise speed during a period from 0.5 t to 1 t is made slower than average voltage rise speed during a period from the initiation of the charging of said piezo stack to 0.5 t.

3. A fuel injection device for an internal combustion engine, comprising:
a piezo injector comprising a piezo stack which, when electrically charged, generates an expansion in a direction in which piezo elements are stacked, and a driving member which moves in said stacking direction by being directly driven with the expansion of said piezo stack, wherein said piezo injector performs fuel injection by causing said driving member to move in said stacking direction with the expansion of said piezo stack; and
a controller for controlling charging and discharging of said piezo stack, wherein
letting t denote a voltage rise time taken from the moment the charging of said piezo stack is initiated until said piezo stack is charged to a target charge voltage, and T denote a combined resonant period of said piezo stack and said driving member,
said controller performs a third voltage rise control in which voltage rise speed during a period within ±0.1 T of a load variation peak occurring in said piezo stack within said voltage rise time t from the initiation of the charging of said piezo stack until said piezo stack is charged to said target charge voltage is made slower than the voltage rise speed during the other periods, and/or voltage rise speed during a period within ±0.1 T of a load variation minimum peak occurring in said piezo stack is made faster than the voltage rise speed during the other periods.

4. A fuel injection device for an internal combustion engine, comprising:
a piezo injector comprising a piezo stack which, when electrically charged, generates an expansion in a direction in which piezo elements are stacked, and a driving member which moves in said stacking direction by being directly driven with the expansion of said piezo stack, wherein said piezo injector performs fuel injection by causing said driving member to move in said stacking direction with the expansion of said piezo stack; and
a controller for controlling charging and discharging of said piezo stack, wherein
letting t denote a voltage rise time taken from the moment the charging of said piezo stack is initiated until said piezo stack is charged to a target charge voltage, and T denote a combined resonant period of said piezo stack and said driving member,
said controller performs a fourth voltage rise control in which a voltage being applied during said voltage rise time t from the initiation of the charging of said piezo stack until said piezo stack is charged to said target charge voltage is reduced for a period within ±0.1 T of a load variation peak occurring in said piezo stack.

5. A fuel injection device for an internal combustion engine, comprising:
a piezo injector comprising a piezo stack which, when electrically charged, generates an expansion in a direction in which piezo elements are stacked, and a driving member which moves in said stacking direction by being directly driven with the expansion of said piezo stack, wherein said piezo injector performs fuel injection by causing said driving member to move in said stacking direction with the expansion of said piezo stack; and
a controller for controlling charging and discharging of said piezo stack, wherein
letting t denote a voltage rise time taken from the moment the charging of said piezo stack is initiated until said piezo stack is charged to a target charge voltage, and T denote a combined resonant period of said piezo stack and said driving member,
if there is any residual resonance occurring in said piezo stack and said driving member due to a preceding injection, said controller performs a fifth voltage rise control in which a voltage opposite in phase to a load variation occurring due to said residual resonance is applied to said piezo stack within said voltage rise time t from the initiation of the charging of said piezo stack until said piezo stack is charged to said target charge voltage.

6. A fuel injection device as claimed in claim 5, wherein said controller performs a sixth voltage rise control in which the voltage opposite in phase to said load variation occurring due to said residual resonance is applied to said piezo stack even after said voltage rise time t has elapsed.

7. A fuel injection device for an internal combustion engine equipped with a piezo injector, said piezo injector comprising:
a piezo stack which, when electrically charged, generates an expansion in a direction in which piezo elements are stacked;
a driving member which moves in said stacking direction by being directly driven with the expansion of said piezo stack;
a slidable holding member which slidably holds said driving member; and
a friction coefficient reducing member, provided in a portion where said driving member and said slidable holding member contact each other, for reducing friction coefficient therebetween, wherein
said piezo injector performs fuel injection by causing said driving member to move in the stacking direction of said piezo stack.

8. A fuel injection device for an internal combustion engine equipped with a piezo injector, said piezo injector comprising:
a piezo stack which, when electrically charged, generates an expansion in a direction in which piezo elements are stacked;
a driving member which moves in said stacking direction by being directly driven with the expansion of said piezo stack;
a fixed member which accepts the expansion of said piezo stack at an end opposite from said driving member; and
a low-rigidity portion provided between said fixed member and said piezo stack and having lower rigidity than said fixed member, wherein
said piezo injector performs fuel injection by causing said driving member to move in the stacking direction of said piezo stack.

9. A fuel injection device as claimed in claim 8, wherein
said fixed member is formed from stainless steel, and
said low-rigidity portion is a low-rigidity member having a Young's modulus of 10 GPa or less.

10. A fuel injection device as claimed in claim 8, wherein said low-rigidity portion is provided on a face where said fixed member accepts the expansion of said piezo stack, and is formed as a roughened surface having a surface roughness of 1.6 Z or larger and a Young's modulus of 10 GPa or less.

11. A fuel injection device for an internal combustion engine equipped with a piezo injector, said piezo injector comprising:
a piezo stack which, when electrically charged, generates an expansion in a direction in which piezo elements are stacked; and
a driving member which moves in said stacking direction by being directly driven with the expansion of said piezo stack, wherein,
of said piezo elements forming said piezo stack, the piezo element located at an end opposite from said driving member has a structure that reduces the internal stress compared with the piezo element located at an end nearer to said driving member, and wherein
said piezo injector performs fuel injection by causing said driving member to move in the stacking direction of said piezo stack.

12. A fuel injection device as claimed in claim 11, wherein, of said piezo elements forming said piezo stack, the piezo element located at the end opposite from said driving member has a larger device diameter than the piezo element located at the end nearer to said driving member.

13. A fuel injection device as claimed in claim 12, wherein, of said piezo elements forming said piezo stack, the device diameter of the piezo element located at the end opposite from said driving member is 3% or more larger than the device diameter of the piezo element located at the end nearer to said driving member.

14. A fuel injection device as claimed in claim 11, wherein of said piezo elements forming said piezo stack, the piezo element located at the end opposite from said driving member has a greater thickness than the piezo element located at the end nearer to said driving member.

15. A fuel injection device as claimed in claim 11, wherein of said piezo elements forming said piezo stack, the thickness of the piezo element located at the end opposite from said driving member is 3% or more greater than the thickness of the piezo element located at the end nearer to said driving member.

16. A fuel injection device for an internal combustion engine equipped with a piezo injector, said piezo injector comprising:
a piezo stack which, when electrically charged, generates an expansion in a direction in which piezo elements are stacked; and
a driving member which moves in said stacking direction by being directly driven with the expansion of said piezo stack, wherein
of said piezo elements forming said piezo stack, the piezo element located at an end opposite from said driving member is made to have a greater device strength than the piezo element located at an end nearer to said driving member, and wherein
said piezo injector performs fuel injection by causing said driving member to move in the stacking direction of said piezo stack.

17. A fuel injection device as claimed in claim 16, wherein of said piezo elements forming said piezo stack, the device strength of the piezo element located at the end opposite from said driving member is 10% or more greater than the device strength of the piezo element located at the end nearer to said driving member.

18. A fuel injection device for an internal combustion engine equipped with a piezo injector, said piezo injector comprising:
a piezo stack which, when electrically charged, generates an expansion in a direction in which piezo elements are stacked;
a driving member which moves in said stacking direction by being directly driven with the expansion of said piezo stack;
a fixed member which accepts the expansion of said piezo stack at an end opposite from said driving member; and
a resilient member, provided between said fixed member and said piezo stack, for applying a compressing force to said piezo stack, wherein
said piezo injector performs fuel injection by causing said driving member to move in the stacking direction of said piezo stack.
